(19) United States
(12) Patent Application Publication
(10) Pub. No.: US 2026/0218568 A1
(43) Pub. Date: Jul. 30, 2026

(54) CONTROL OF COVERING MATERIAL AND MOTORIZED WINDOW TREATMENTS

(71) Applicant: Lutron Technology Company LLC, Coopersburg, PA (US)

(72) Inventors: Craig Alan Casey, Coopersburg, PA (US); Kevin Dalbey, Quakertown, PA (US); David A. Kirby, Zionsville, PA (US); Sanjeev Kumar, Harleysville, PA (US); Joan S. Kurylak, Bethlehem, PA (US); Somesh Rahul, Breinigsville, PA (US)

(73) Assignee: Lutron Technology Company LLC, Coopersburg, PA (US)

(21) Appl. No.: 19/629,473

(22) Filed: Mar. 26, 2026

Related U.S. Application Data
(63) Continuation of application No. 17/766,126, filed on Oct. 2, 2020, now abandoned.
(60) Provisional application No. 62/910,979, filed on Oct. 4, 2019.

(51) Int. Cl. E06B 9/42; E06B 9/24; E06B 9/262; E06B 9/264; E06B 9/68; E06B 9/72

(52) U.S. Cl. CPC E06B 9/42; E06B 9/262; E06B 9/264; E06B 9/72; E06B 2009/2405; E06B 2009/2417; E06B 2009/2435; E06B 2009/2452; E06B 2009/2464; E06B 2009/247; E06B 2009/2627; E06B 2009/6809

(57) ABSTRACT

A motorized window treatment may include a roller tube, a covering material that is attached to the roller tube, and a motor drive unit configured to be located within the roller tube. The motor drive unit may include a motor drive shaft defining a motor drive shaft rotational axis in a longitudinal direction. The motor drive shaft may be configured to rotate the roller tube to adjust the covering material between a raised position and a lowered position. The motorized window treatment may be configured to adjust a visible light transmittance of the covering material by rotating the roller tube, for example, when the covering material is in a fixed position between the raised position and the lowered position.

### CROSS-REFERENCE TO RELATED APPLICATIONS

This application is a continuation of non-provisional U.S. application Ser. No. 17/766,126, filed Apr. 1, 2022, which is a U.S. National Stage Application of PCT Application No. PCT/US2020/054092, filed Oct. 2, 2020, which claims the benefit of Provisional U.S. Patent Application No. 62/910,979, filed Oct. 4, 2019, the disclosure of which is incorporated herein by reference in their entirety.

### BACKGROUND

Traditional window treatments may be installed in a space to allow/limit amount of natural light entering the space. The traditional window treatments may also provide privacy when they are closed, while letting some amount of natural light through. The window treatments may have covering materials with different visible light transmittance, transparency, colors, patterns, styles, and/or other characteristic of the covering material. The number of different window treatment available to users may be countless.

The window treatments may become a fixture in the space once users select and install the window treatments. The users may change their minds and/or the users may not like the selected and/or installed shades. Replacing the window treatments and installing the different window treatments may be costly and burdensome, and the window treatments may still end up being insufficient for the intended function.

### SUMMARY

Systems, methods, and apparatus are described for controlling a covering material (e.g., a flexible material, a shade fabric, and/or the like) of a motorized window treatment in a space. The covering material may have variable visible light transmittance, opacity (e.g., transparency), color, pattern, and/or other characteristics of the covering material. For example, the variable light transmittance of the covering material may be adjusted to allow an amount of light to enter the space and/or limit the amount of light entering the space. In addition, the opacity of the covering material may be adjusted to adjust how well people can see through the covering material. Further, the covering material may have integral light sources, such as light emitting diodes (LEDs), and may be configured to emit a variable amount of light.

The covering material may have variable visible light transmittance and/or opacity (e.g., transparency). For example, the covering material may be adjusted to have a transparent state, a translucent state, and/or an opaque state (e.g., a blackout state). In the transparent state, the covering material may allow natural light to enter the space. A user may be able to see outside of the window and may have less privacy from others as they can see inside of the space. In the translucent state, the covering material may allow some natural light to enter the space. The user may still be able to see outside (e.g., the shadows of objects outside of the window) and may have some privacy. In the opaque state, the covering material may prevent natural light from entering the space. The user may be unable to see outside and may have complete privacy.

The covering material may have integral light sources, such as LEDs, on the fabric and/or proximate to the covering material. For example, the covering material may have LEDs on a hembar and/or on a mounting bracket of the motorized window treatment. The covering material may adjust the intensities of the LEDs to imitate natural light entering the space. For example, the covering material may increase the intensities of the LEDs on or proximate to the covering material to imitate a color and/or brightness level of a sunrise setting. The covering material may decrease the intensities of the LEDs on or proximate to the covering material to imitate a color and/or brightness level of a sunset setting.

The covering material may have adjustable color-shades, pattern-shades, and/or other characteristic of the covering material. The user may adjust the color, pattern, styles, and/or other characteristic of the covering material after installing the covering material. For example, the user may adjust the covering material based on the season, occasion, holiday, and/or the like.

A motorized window treatment may include a roller tube, a covering material that is attached to the roller tube, and a motor drive unit configured to be located within the roller tube. The motor drive unit may include a motor drive shaft defining a motor drive shaft rotational axis in a longitudinal direction. The motor drive shaft may be configured to rotate the roller tube to adjust the covering material between a raised position and a lowered position. The motorized window treatment may be configured to adjust a visible light transmittance of the covering material, for example, when the covering material is in a fixed position between the raised position and the lowered position.

The motorized window treatment may be configured to adjust the visible light transmittance of the covering material by moving the covering material. The covering material may include a first panel defining a first mesh weave with a plurality of first fabric strands and a second panel defining a second mesh weave with a plurality of second fabric strands. The first panel may be on a non-window side of the motorized window treatment and the second panel is on a window side of the motorized window treatment. The first mesh weave may include a first pattern such that the first plurality of fabric strands define a first plurality of vertices and the second mesh weave may include a second pattern such that the second plurality of fabric strands define a second plurality of vertices. The first pattern and the second pattern may be the same. The first panel may remain stationary as the second panel is configured to be translated between a first position and a second position. When the second panel is in the first position, the first mesh weave may be aligned with the second mesh weave, for example, such that the visible light transmittance of the covering material is at a maximum. When the second panel is in the second position, the second plurality of vertices may be located at midpoint between the first plurality of vertices, for example, such that the visible light transmittance of the covering material is at a minimum. The second panel may be configured to be translated in two dimensions.

The motorized window treatment may be configured to adjust the visible light transmittance of the covering material by stretching the covering material by rotating the roller tube. The motorized window treatment may include a hembar configured to engage a lower end of the covering material. The hembar may be stationary when the visible light transmittance of the covering material is adjusted. The motorized window treatment may be configured to stretch the covering material when the hembar is in a locked position with respect to the roller tube. The locked position may be a first locked position. The motorized window treatment may be configured to rotate the roller tube to move the hembar to the first locked position. The motorized window treatment may be configured to lock the hembar in the first locked position. The motorized window treatment may be configured to rotate the roller tube in the direction that raises the hembar to stretch the covering material when the hembar is in the first locked position.

The motorized window treatment may be configured to adjust the visible light transmittance of a stretched covering material. The motorized window treatment may be configured to rotate the roller tube in the direction that lowers the hembar to unstretch the covering material. The motorized window treatment may be configured to unlock the hembar from the first locked position. The motorized window treatment may be configured to rotate the roller tube to move the hembar to a second locked position. The motorized window treatment may be configured to lock the hembar in the second locked position. The motorized window treatment may be configured to rotate the roller tube in the direction that raises the hembar to stretch the covering material when the hembar is in the second locked position. The hembar may be moved to the first locked position and the second locked position based on a privacy setting or a position of the sun. The motorized window treatment may be configured to rotate the roller tube to stretch the covering material between a first visible light transmittance and a second visible light transmittance. The motorized window treatment may include one or more cables that extend parallel to the covering material and through the hembar, the one or more cable configured to enable the hembar to be locked in the locked position. Each of the one or more cables may include a mounting structure at each end of the respective cable. The mounting structure may be configured to be attached to the structure surrounding the window. The hembar may include a clamp for each of the one or more cables. The clamp may be configured to clamp the respective cable to lock the hembar in the locked position. The hembar may include a hembar control unit that is configured to control the clamp based on control instructions received from an external control device. The motorized window treatment may be configured to rotate the roller tube while the hembar is in the locked position, for example, to stretch the covering material and/or adjust the visible light transmittance of the covering material. The motorized window treatment may include one or more wireless communication components configured to communicate wireless messages with an external control device. The motorized window treatment may be configured to adjust the visible light transmittance of the covering material based on control instructions received from the external control device by the one or more wireless communication components.

In examples, a motorized window treatment may be configured to change a visible light transmittance of a covering material (e.g., shade fabric) using heat and/or electricity. The motorized window treatment may include a control unit that is configured to adjust the visible light transmittance of the covering material by applying heat and/or electricity to the covering material. The control unit may be located within a roller tube, a hembar, or the covering material of the motorized window treatment. The control unit may be configured to adjust the visible light transmittance of the covering material by adjusting a temperature of the covering material. The temperature adjustment may be determined based on a desired amount of light to allow into a room through a window proximate to the motorized window treatment. Heat may be applied to the covering material until a target visible light transmittance is achieved for the covering material. The target visible light transmittance may correspond to a desired amount of light to allow into a room through a window proximate to the motorized window treatment. The covering material may include electrical wiring that is configured to conduct a current such that the temperature of the covering material can be increased and decreased. When the temperature of the covering material is increased, the covering material may expand such that the thickness of the covering material is increased and/or the visible light transmittance of the covering material is increased. When the temperature of the covering material is decreased, the covering material may contract such that the thickness of the covering material is decreased and/or the visible light transmittance of the covering material is decreased.

The covering material may include a plurality of zones. The control unit may be configured to adjust the visible light transmittance of each of the plurality of zones independently. The control unit may be configured to determine which of the plurality of zones are wrapped around the roller tube and/or which of the plurality of zones are unwrapped around the roller tube. The control unit may be configured to adjust the visible light transmittance of the zones that are not wrapped around the roller tube. The control unit may be configured to determine a length of unwrapped covering material. The control unit may be configured to determine which of the plurality of zones are in the length of unwrapped covering material. The control unit may be configured to adjust the visible light transmittance of the zones in the length of unwrapped covering material. When the control unit is located within the covering material, the control unit may communicate with a motor drive control unit to receive control instructions indicating whether to apply the heat or electricity to the covering material. The control instructions may be received wirelessly.

In examples, the motorized window treatment may be configured to change a visible light transmittance of a covering material using adjustable vanes. The covering material may be attached to the roller tube. The covering material may include a first panel, a second panel, and a plurality of vanes that extend between the first panel and the second panel. The motorized window treatment is configured to adjust the visible light transmittance of the covering material by adjusting one or more of the plurality of vanes. The plurality of vanes may include a plurality of adjustable vanes that are configured to be tilted to adjust the visible light transmittance of the covering material. The plurality of vanes may include a plurality of fixed vanes. Each of the plurality of fixed vanes may be attached to the first panel and the second panel. The motorized window treatment may include a tilt cord. Each of the plurality of adjustable vanes may define a first end that is attached to the first panel and a second end that is attached to the tilt cord. The motorized window treatment may be configured to raise and lower the tilt cord to tilt the plurality of adjustable vanes between an open position and a closed position. The second end of each of the plurality of adjustable vanes may be proximate to a respective fixed vane of the plurality of fixed vanes when the plurality of adjustable vanes are in the open position. The second end of each of the plurality of adjustable vanes may be distal from the respective fixed vane of the plurality of fixed vanes when the plurality of adjustable vanes are in the closed position. The visible light transmittance of the covering material may be increased as the tilt cord is raised. The visible light transmittance of the covering material may be decreased as the tilt cord is lowered. The plurality of adjustable vanes and the plurality of fixed vanes may define a curved cross-section to enable winding about the roller tube.

The plurality of adjustable vanes may include a first plurality of adjustable vanes and a second plurality of adjustable vanes. The motorized window treatment may include a second tilt cord that is capable of being operated independently from the first tilt cord such that the second plurality of adjustable vanes can be tilted to a different position than the first plurality of adjustable vanes. The first plurality of vanes may have a different transparency than the second plurality of adjustable vanes. The first plurality of adjustable vanes may be more transparent than the second plurality of vanes. The motorized window treatment may be configured to adjust the plurality of vanes to change one or more of a color of the covering material or a color of the light transmitted through the covering material. Each of the plurality of vanes may be configured to change color. Each of the plurality of vanes may include one or more light sources that are configured to change the color of the respective vane of the plurality of vanes. The visible light transmittance of the motorized window treatment is adjusted by controlling the first plurality of adjustable vanes and the second plurality of adjustable vanes.

In examples, the motorized window treatment may include a covering material with integrated lights. For example, the motorized window treatment may include a plurality of light sources located in the covering material. The motorized window treatment may include a control unit configured to control one or more of an intensity or a color of the plurality of light sources. The covering material may be a cellular shade comprising a plurality of cell structures that are aligned vertically. The plurality of cell structures may be hexagonal prisms that are collapsible as the covering material is operated between the raised and lowered position. The plurality of light sources may be located within one or more of the plurality of cell structures. The control unit may be configured to separately control the light sources within each cell structure of the plurality of cell structures. The control unit may be configured to separately control each of the plurality of light sources. The control unit may be configured to control the plurality of light sources to display an image or text.

The motorized window treatment may include a headrail, a spool that is operably coupled to the motor drive shaft, and a lift cord attached to the spool. Rotation of the spool may enable the lift cord to raise and lower the covering material between the raised position and the lowered position. The control unit may be configured to determine a length of covering material that is extended from the headrail. The motorized window treatment may include a hembar attached to a lower edge of the covering material. The control unit may be configured to determine the distance between the hembar and the headrail. The control unit may be configured to control the intensity of the plurality of light sources in the length of covering material that is extended from the headrail. The control unit may be configured to control the plurality of light sources to simulate natural light. The control unit may be configured to control the plurality of light sources to simulate one or more of a sunrise or a sunset. The plurality of light sources may be configured to illuminate a window side and/or a non-window side of the covering material. Each of the plurality of light sources may include a light-emitting diode (LED). The control unit may be coupled to the covering material, for example, to adjust the color of the covering material using one or more of the plurality of light sources. The control unit may be configured to control the plurality of light sources in response to detection of a gesture proximate to the motorized window treatment.

In examples, the motorized window treatment may be configured to change a color and/or a pattern of the covering material. The motorized window treatment may include a control unit that is configured to adjust the color and the pattern of the covering material in response to receipt of control instructions. The motorized window treatment may include one or more sensors configured to send the control instructions to the control unit. The control unit may be coupled to the covering material to change the color or pattern of the covering material. The control unit may be configured to adjust the color or pattern of the covering material in response to detection of a gesture proximate to the motorized window treatment. The covering material may include a flexible light-emitting diode (LED) display. The flexible LED display may be configured to display a plurality of patterns and images stored in a memory. The motorized window treatment may include a video input. The flexible LED display may be configured to display images received via the video input.

### BRIEF DESCRIPTION OF THE DRAWINGS

FIG. 1A is a diagram of an example load control system for controlling one or more load control devices.

FIG. 1B is a diagram of another example load control system for controlling one or more load control devices.

FIG. 2A is a block diagram illustrating an example motorized window treatment.

FIG. 2B is a block diagram illustrating another example motorized window treatment.

FIG. 2C is a block diagram illustrating another example motorized window treatment.

FIG. 2D is a block diagram illustrating another example motorized window treatment.

FIG. 3 is a flowchart of an example process for controlling a motorized window treatment.

FIG. 4 is a flowchart of an example process for controlling a motorized window treatment.

FIG. 5 is an example motorized window treatment having a covering material with a variable thickness.

FIG. 6 is a flowchart of an example process for controlling a covering material with a variable thickness.

FIG. 7 is an example motorized window treatment having a stretchable covering material.

FIG. 8 is a flowchart of an example process for controlling a stretchable covering material.

FIG. 9 is an example motorized window treatment having a covering material with adjustable vanes.

FIG. 10 is another example motorized window treatment having a covering material with adjustable vanes.

FIG. 11 is an example motorized window treatment having a cellular covering material.

FIGS. 12A and 12B are front views of a portion of an example covering material characterized by a variable visible light transmittance and/or opacity.

FIG. 13 is a block diagram illustrating an example system controller.

FIG. 14 is a block diagram illustrating an example control-target device.

FIG. 15 is a block diagram illustrating an example control-source device.

FIG. 16 is a block diagram illustrating an example network device.

### DETAILED DESCRIPTION

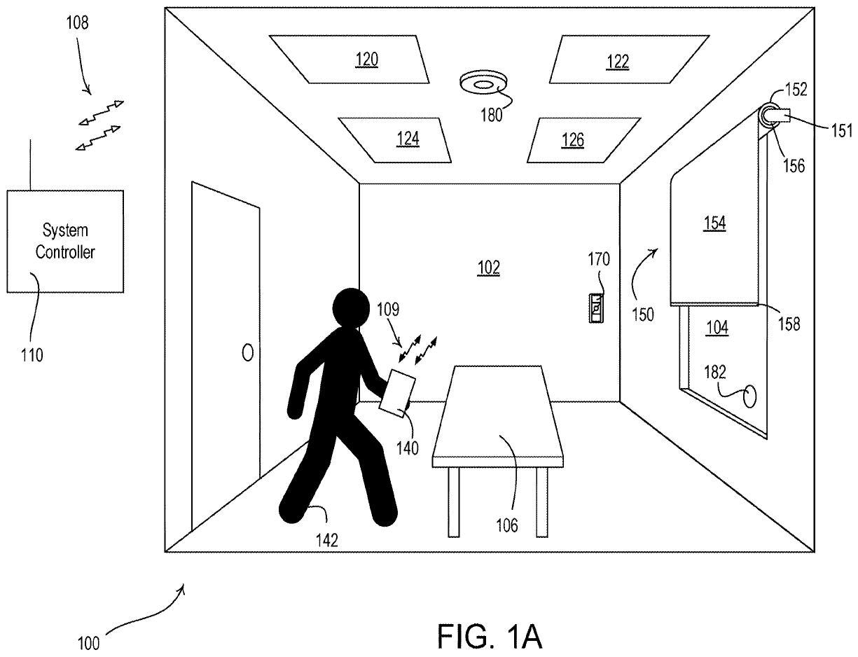

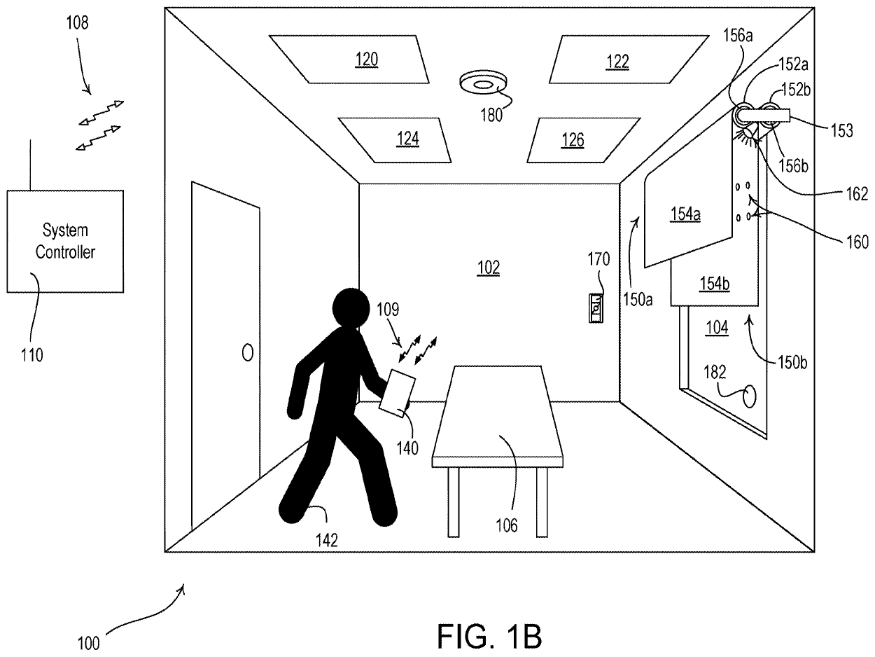

FIG. 1A is a diagram of an example load control system 100 for controlling one or more load control devices. The load control system 100 may be installed in a room 102 of a building or a residential home. The load control system 100 may comprise a plurality of control devices configured to communicate with each other via wireless signals, e.g., radio-frequency (RF) signals 108. Alternatively, or additionally, the load control system 100 may comprise a wired digital communication link coupled to one or more of the control devices to provide for communication between the control devices.

The control devices of the load control system 100 may comprise a number of control-source devices (e.g., input devices operable to transmit messages (e.g., digital messages) in response to user inputs, changes in measured light intensity, and/or the like) and/or a number of control-target devices (e.g., load control devices operable to receive messages and control respective electrical loads in response to the received messages). A single control device of the load control system 100 may operate as both a control-source and a control-target device.

The control-source devices may be configured to transmit messages directly to the control-target devices. In addition, the load control system 100 may comprise a system controller 110 (e.g., a central processor or load controller) operable to communicate messages to and/or from the control devices (e.g., the control-source devices and/or the control-target devices). For example, the system controller 110 may be configured to receive messages from the control-source devices and transmit messages to the control-target devices in response to the messages received from the control-source devices. The control-source devices, the control-target devices, and the system controller 110 may be configured to transmit and receive the RF signals 108 using a proprietary RF protocol, such as the CLEAR CONNECT protocol (e.g., the CLEAR CONNECT TYPE A or CLEAR CONNECT TYPE X protocols). Alternatively, the RF signals 108 may be transmitted using a different RF protocol, such as, a standard protocol, for example, one of WIFI, BLUETOOTH, BLUETOOTH LOW ENERGY (BLE), ZIGBEE, Z-WAVE, KNX-RF, THREAD, ENOCEAN RADIO protocols, or another protocol.

The control-target devices in the load control system 100 may comprise lighting control devices located within lighting fixtures 120-126. The lighting control devices in the lighting fixtures 120-126 may be light-emitting diode (LED) drivers for driving an LED light source (e.g., an LED light engine). The LED drivers may be located in or adjacent to the lighting fixtures 120-126. Each LED driver may be configured to receive messages via the RF signals 108 (e.g., from the system controller 110 or directly from a control-source device) and to control the LED light source in response to the received messages. The LED driver may be configured to adjust the intensity and/or color (e.g., color temperature) of the LED light source in response to the received messages. Examples of LED drivers configured to control the color temperature of LED light sources are described in greater detail in commonly-assigned U.S. Pat. No. 9,538,603, issued Jan. 3, 2017, entitled SYSTEMS AND METHODS FOR CONTROLLING COLOR TEMPERATURE, the entire disclosure of which is hereby incorporated by reference. One or more other example LED drivers may be used.

The LED drivers within lighting fixtures 120-126 may adjust the color temperature of the LED light sources to change the color temperature) based on the time of day and/or different modes of operation. For example, the LED drivers may adjust the color temperature of the LED light sources to imitate the color temperature during sunrise and sunset at the appropriate times of day, month, season, and/or the like. An example of a load control system that is configured to present a “natural show” to imitate the color temperature of daylight conditions is described in greater detail in U.S. Pat. No. 9,674,917, issued Jun. 6, 2017, entitled ILLUMINATION SYSTEM AND METHOD THAT PRESENTS A NATURAL SHOW TO EMULATE DAYLIGHT CONDITIONS WITH SMOOTHING DIMCURVE MODIFICATION THEREOF, the entire disclosure of which is hereby incorporated by reference. One or more other example load control systems may be implemented. In an example embodiment, the LED drivers within the lighting fixtures 120-126 may control the color temperature to 2,200 Kelvin (K) at dawn, 3,500 K in the morning hours, 4,000 K in the afternoon hours, 3,000 K in the early evening hours, 2,500 K at sunset, 2,100 K after sundown, and/or 1,900 K at night during a sleep mode. The color temperature changes may be performed by the LED drivers based on commands from the system controller 110, or messages from other devices within the load control system 100 (e.g., control-source devices). The load control system 100 may further comprise other types of lighting control devices, such as, for example, electronic dimming ballasts for driving fluorescent lamps.

The control-target devices within the load control system 100 may comprise one or more daylight control devices, e.g., a motorized window treatment 150. The motorized window treatment 150 may comprise a roller tube 152 for controlling the amount of outside light entering the room 102 through a window 104. The motorized window treatment 150 may comprise a covering material, such as a covering material 154 (e.g., a flexible material). The covering material 154 may be a fabric, a plastic, a composite, or some other material. The covering material 154 may be hanging in front of the window 104 and windingly received around the roller tube 152. The roller tube 152 may be rotatably supported by mounting brackets 151 located at both ends of the roller tube 152.

One or more physical characteristics of the covering material 154 may be variable. For example, the covering material 154 may have a variable visible light transmittance, opacity, color, pattern, style, amount of light emitted, and/or other characteristic of the covering material. The visible light transmittance of the covering material 154 may be adjusted to control an amount of light entering the space 102 from the outside through the covering material. As described below, the visible light transmittance of the covering material 154 may be adjusted so that the covering material 154 may have a transparent state, a translucent state, or an opaque state (e.g., a blackout state). In addition, the covering material 154 may be configured to emit a variable amount of electric light. The covering material 154 may have one or more light sources on or proximate to the covering material 154. The covering material 154 may exhibit different colors, patterns, styles, and/or other characteristic of the covering material to fit the preference of a user. For example, the covering material 154 may be adjusted to warmer or cooler sheer fabric. The warmer sheer fabric may have warmer colors (e.g., or warmer shades of a given color), and a cooler sheer fabric may have cooler colors (e.g., or cooler shades of a given color). Warmer colors may have a relatively low color temperature (e.g., within a range of approximately 2600 K to 3700 K), while cooler colors may have a relatively high color temperature (e.g., within a range of approximately 5000 K to 8300 K). The covering material 154 may affect the color temperature of light within a space. For example, outside light shining through a warmer sheer fabric may cause the color temperature in the space to decrease, and outside light shining through a cooler sheer fabric may cause the color temperature of the space to increase.

The opacity of the covering material 154 may be controlled. For example, the opacity of the covering material 154 may be adjusted to obscure a view into the space 102 via the window 104 and/or a view out of the space 102 via the window 104. The opacity of the covering material 154 may be a measure of the covering material's impenetrability to visible light.

The motorized window treatment 150 may further comprise a motor drive unit 156 located inside of the roller tube 152. The motor drive unit 156 may be configured to rotate the roller tube 152 for raising and lowering the covering material 154 to control the amount of outside light (e.g., daylight) entering the room 102. The motor drive unit 156 of the motorized window treatment 150 may be configured to receive messages via the RF signals 108 (e.g., from the system controller 110 or a control-source device) and adjust the position of the covering material 154 in response to the received messages. The load control system 100 may comprise other types of daylight control devices, such as, for example, a cellular shade, a drapery, a Roman shade, a Venetian blind, a Persian blind, a pleated blind, a tensioned roller shade system, an electrochromic or smart window, controllable window films, and/or other suitable daylight control device. Examples of battery-powered motorized window treatments are described in greater detail in U.S. Pat. No. 8,950,461, issued Feb. 10, 2015, entitled MOTORIZED WINDOW TREATMENT, and U.S. Pat. No. 9,488,000, issued Nov. 8, 2016, entitled INTEGRATED ACCESSIBLE BATTERY COMPARTMENT FOR MOTORIZED WINDOW TREATMENT, the entire disclosures of which are hereby incorporated by reference. One or more other example motorized window treatments may be used.

The motorized window treatment 150 may be controlled such that a hembar 158, or a bottom of the covering material 154, is at a certain position (e.g., window treatment level) on the window 104. The motorized window treatment 150 may be controlled in response to messages from a control-source device (e.g., button press on remote control 170, sensor information, and/or the like). The motorized window treatment 150 may be automatically controlled to a certain position (e.g., by the system controller 110, a control-source device, or another device in the system) based on a shade control mode (e.g., scene) and/or user preference. An example of an automated control system for motorized window treatments is described in greater detail in U.S. Pat. No. 8,786,236, issued Jul. 22, 2014, entitled METHOD OF AUTOMATICALLY CONTROLLING A MOTORIZED WINDOW TREATMENT WHILE MINIMIZING OCCUPANT DISTRACTIONS, the entire disclosure of which is hereby incorporated by reference. One or more other example automated control systems for motorized window treatments may be implemented. The shade control mode and/or user preferences may be implemented by control parameters for providing the control mode and/or user preferences. For example, the position of the covering material 154 may be controlled to a certain position based on the time of day, date, location of the building, location of the room 102 in the building, location of the window 104, weather, season, shadows, location of the occupant 142 in the room, location of the occupant's mobile device 140 in the room, occupancy/vacancy of the room 102, a location of a workspace 106 in the room 102, a view setting for allowing occupants to have an outside view, a privacy setting for allowing occupants to have privacy from the outside view, a glare setting for preventing daylight glare for an occupant within the space, characteristics of the covering material 154 (e.g., openness factor for allowing light into space, color, and/or other characteristic of the covering material 154), and/or the current position of the covering material 154 on the window.

Though the load control system 100 shows the motorized window treatment 150 having covering material 154, and more window treatments may be implemented. For example, the load control system 100 may comprise a single motorized window treatment having a covering material having multiple panels of different materials (e.g., a warm sheer fabric panel, a cool sheer fabric panel, a blackout fabric panel, etc.). An example of a load control system having a single motorized window treatment that may have multiple panels is described in U.S. Pat. No. 5,467,266, issued on Nov. 14, 1995, entitled MOTOR-OPERATED WINDOW COVER, the entire disclosures of which are hereby incorporated by reference. One or more other load control systems having a single motorized window treatment that may have multiple panels may be implemented. Electrochromic glass may be used to adjust the color temperature of outside light that is entering the space (e.g., in place of blackout and/or sheer fabric).

The load control system 100 may comprise one or more control-source devices, e.g., such as a remote control device 170, an inside sensor 180 (e.g., such as a visible light sensor, an inside ambient light sensor, and/or a daylight sensor), or an outside sensor 182 (e.g., such as a visible light sensor, an outside ambient light sensor, a daylight sensor, and/or a window sensor). The system controller 110 may be configured to transmit one or more messages to the control-target devices (e.g., the LED drivers in lighting fixtures 120-126 and/or the motorized window treatment 150) in response to the messages received from the control-source devices. The control-source devices may also, or alternatively, communicate directly with the control-target devices via wired or wireless communications.

The remote control device 170 may be configured to transmit messages via the RF signals 108 to the system controller 110 (e.g., directly to the system controller) in response to an actuation of one or more buttons of the remote control device 170. The messages may include an identifier of a type of actuation performed on the device. The message may indicate or include a lighting color/brightness of the space, a dimming intensity, a relative change in color/brightness, a relative change in dimming intensity, and/or a predefined scene. The remote control device 170 may be battery-powered. The remote control device 170 may be installed in a wall of the room 102 and/or may be a mobile device.

The inside sensor 180 may be installed in the interior of the room 102 and may provide a measurement inside of the space. For example, the inside sensor 180 may measure ambient light condition of the room 102 (e.g., within a viewable range in the room 102 below the inside sensor). For example, the inside sensor 180 may measure a color temperature of the light inside the room 102. The viewable range may include a space that may be affected by the light emitted from the multiple lighting fixtures 120-126 and/or outside light shining through the window 104. The inside sensor 180 may communicate (e.g., via wired or wireless communication) with the lighting control devices of the lighting fixtures 120-126, or other load control devices, via the system controller 110 (e.g., to create a closed-loop color control). The inside sensor 180 may also, or alternatively, communicate directly (e.g., via wired or wireless communication) with the lighting control devices. The inside sensor 180 may communicate (e.g., via wired or wireless communication) with the motorized window treatment 150. The inside sensor 180 may also, or alternatively, communicate directly (e.g., via wired or wireless communication) with the motorized window treatment 150 (e.g., to change visible light transmittance of the covering material 154, the intensity level of light emitted by the window treatment 150, and/or the color of the covering material 154).

The outside sensor 182 may provide a measurement outside of the room 102 (e.g., shining onto the window 104). The outside sensor 182 may be installed on the interior or exterior of the window 104, or on the exterior or the building, to provide the measurement, such as the outside light condition (e.g., the color temperature of the light outside the room 102). The outside sensor 182 may communicate (e.g., via wired or wireless communication) with the lighting control devices of the lighting fixtures 120-126, or other load control devices, via the system controller 110 (e.g., to create an open-loop color control). The outside sensor 182 may also, or alternatively, communicate directly (e.g., via wired or wireless communication) with the lighting control devices. The outside sensor 182 may communicate (e.g., via wired or wireless communication) with the motorized window treatment 150. The outside sensor 182 may also, or alternatively, communicate directly (e.g., via wired or wireless communication) with the motorized window treatment 150 (e.g., to change the visible light transmittance of the covering material 154, the intensity level of light emitted by the window treatment 150, and/or the color of the covering material 154). The intensity level of the light emitted by the window treatment 150 may be referred to as a lighting configuration.

The system controller 110 may be coupled to a network, such as a wireless or wired local area network (LAN), e.g., for access to the Internet. The system controller 110 may be wirelessly connected to the network, e.g., using WIFI or cellular technology. The system controller 110 may be coupled to the network via a network communication bus (e.g., an Ethernet communication link). The system controller 110 may be configured to communicate via the network with one or more network devices, e.g., a mobile device 140, such as, a personal computing device and/or a wearable wireless device. The mobile device 140 may be located on an occupant 142. For example, the mobile device 140 may be attached to the occupant's body or clothing or may be held by the occupant. The mobile device 140 may be characterized by a unique identifier (e.g., a serial number or address stored in memory) that uniquely identifies the mobile device 140 and thus the occupant 142. Examples of personal computing devices may include a smart phone, a laptop, and/or a tablet device (for example, a hand-held computing device). Examples of wearable wireless devices may include an activity tracking device, a smart watch, smart clothing, and/or smart glasses. In addition, the system controller 110 may be configured to communicate via the network with one or more other control systems (e.g., a building management system, a security system, etc.).

The mobile device 140 may be configured to transmit messages to the system controller 110, for example, in one or more Internet Protocol packets. For example, the mobile device 140 may be configured to transmit messages to the system controller 110 over the LAN and/or via the Internet. The mobile device 140 may be configured to transmit messages over the Internet to an external service, and the messages may be received by the system controller 110. Alternatively, or additionally, the mobile device 140 may be configured to transmit RF signals 109 according to another protocol. The load control system 100 may comprise other types of network devices coupled to the network, such as a desktop personal computer, a wireless-communication-capable television, or any other suitable Internet-Protocol-enabled device. Examples of load control systems operable to communicate with mobile and/or network devices on a network are described in greater detail in commonly-assigned U.S. Patent Application Publication No. 2013/0030589, published Jan. 31, 2013, entitled LOAD CONTROL DEVICE HAVING INTERNET CONNECTIVITY, the entire disclosure of which is hereby incorporated by reference. One or more other load control systems operable to communicate with mobile and/or network devices on a network may be implemented.

The operation of the load control system 100 may be programmed, configured, and/or controlled using, for example, the mobile device 140 or other network device (e.g., when the mobile device is a personal computing device). The mobile device 140 may execute a graphical user interface (GUI) configuration software for allowing a user to program how the load control system 100 will operate. For example, the configuration software may run as a PC application or a web interface. The configuration software and/or the system controller 110 (e.g., via instructions from the configuration software) may generate a load control database that defines the operation of the load control system 100. For example, the load control database may include information regarding the operational settings of different load control devices of the load control system (e.g., the lighting control devices and/or the motorized window treatment 150). The load control database may comprise information regarding associations between control target devices and the control-source devices. The load control database may comprise information regarding how the control-target devices respond to messages received from the control-source devices. Examples of configuration procedures for load control systems are described in greater detail in commonly-assigned U.S. Patent Application Publication No. 2014/0265568, published Sep. 18, 2018, entitled COMMISSIONING LOAD CONTROL SYSTEMS, the entire disclosure of which is hereby incorporated by reference. One or more other configuration procedures for load control systems on a network may be used.

The system controller 110 may be configured to automatically operate according to control parameters in a programmed control mode or indicated in user preferences (e.g., preprogrammed user preferences, commands from the remote control device 170, commands from the mobile device 140, etc.) to turn the lighting loads in the lighting fixtures 120-126 on and off, change the intensity level of the lighting loads in the lighting fixtures 120-126, change the color (e.g., color temperature) of the lighting loads in the lighting fixtures 120-126, and/or control the motorized window treatment 150. For example, the system controller 110 may be configured to change the color temperature of the light emitted by the lighting loads in lighting fixtures 120-126 over the course of a day, while also being configured to open the motorized window treatment 150 to allow for a view outside of the window 104 by the occupant 142 during certain times of day and/or close the covering material 154 to provide privacy to the occupant 142 and/or prevent glare during certain times of day. As the color temperature in the room 102 may be affected by the color temperature of the outside light entering the space through the window 102, the position and/or the characteristics of the covering material 154 (e.g., openness factor for allowing light into space, color, etc.) may be considered with the color temperature of the light emitted by the lighting fixtures 120-126 to achieve the desired color temperature within the room 102, or portions thereof. As some control modes or user preferences may prioritize moving the position of window treatments, while others may prioritize changing the color temperature of the lighting loads in lighting fixtures, the system may be controlled according to the given preference, but may be overridden to achieve a setpoint color temperature (e.g., a desired color temperature).

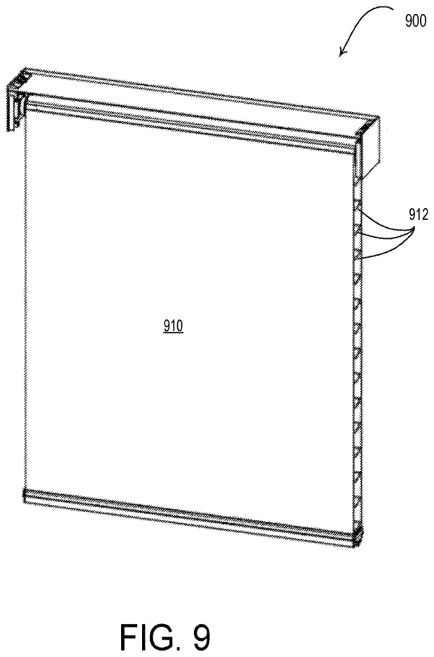

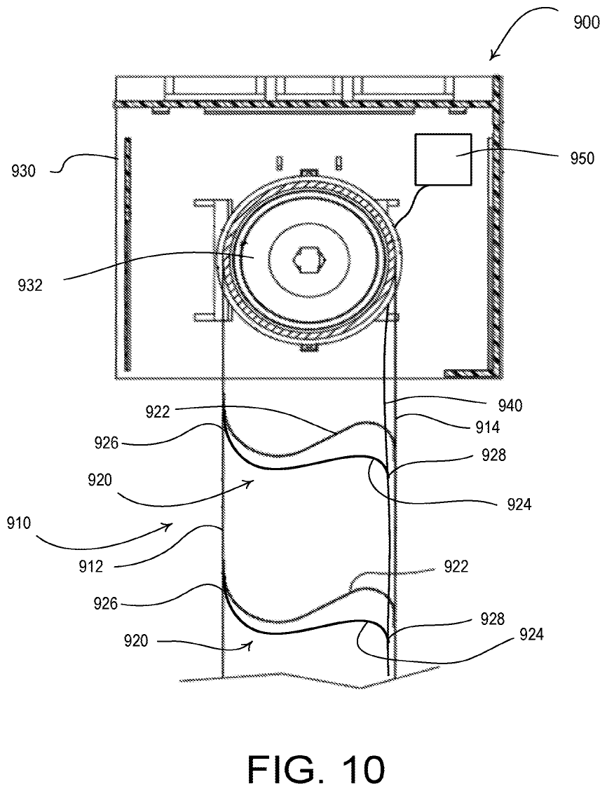

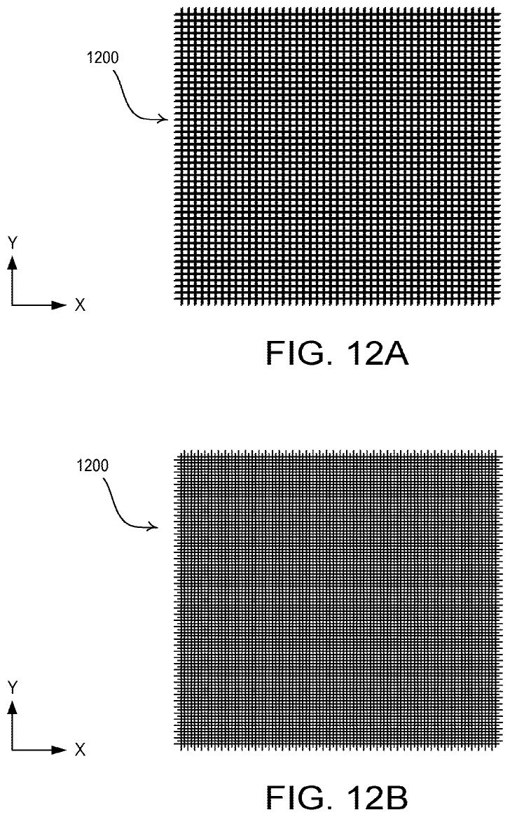

The motorized window treatment 150 may be configured to adjust a visible light transmittance, a color, and/or a lighting configuration of the covering material 154 of the motorized window treatment 150. The visible light transmittance of the covering material 154 may be associated with an openness factor of the covering material 154, for example, when the covering material 154 defines fabric weaves (e.g., such as the covering material 1200 shown in FIG. 12A and FIG. 12B), includes a plurality of holes, includes surface texture, and/or includes adjustable vanes (e.g., such as the covering material 910 shown in FIG. 9 and FIG. 10). When the covering material 154 defines a plurality of holes and/or a surface texture, stretching the covering material 154 may adjust the visible light transmittance of the covering material by changing the size of the holes and/or changing a pattern or scale of the surface texture. The visible light transmittance of the covering material 154 may be associated with a translucency and/or transparency of the covering material 154. A translucent covering material may obscure a view into the room 102 while filtering some visible light entering the room 102. A transparent covering material may provide a clear (e.g., unobscured) view into the room 102 while allowing visible light to enter the room 102. For example, the openness factor of the covering material 154 may be increased to achieve an increased visible light transmittance. The translucency and/or transparency of the covering material 154 may be increased to achieve an increased visible light transmittance. For example, the motorized window treatment 150 may be configured to determine a present visible light transmittance, a present color, and/or a present lighting configuration of the covering material 154. The motorized window treatment 150 may adjust the covering material 154 to a target visible light transmittance, a target color, and/or a target lighting configuration, for example, based on a trigger. For example, the motorized window treatment 150 may receive a trigger. The trigger may be a command (e.g., that indicates that the motorized window treatment 150 should adjust the covering material 154). The trigger may indicate the target visible light transmittance, the target color, a target thickness, and/or the target lighting configuration. The trigger may be associated with a user's privacy and/or lighting desires.

The visible light transmittance of the covering material 154 may be adjusted, for example, when the covering material 154 is in a fixed position (e.g., a locked position). The covering material 154 may be in the fixed position when the hembar 158 is locked to prevent vertical movement. The roller tube 152 may be rotated when the covering material 154 (e.g., the hembar 158) is in the fixed position. For example, the roller tube 152 may be rotated in the raising direction when the hembar 158 is in the fixed position to stretch the covering material 154. The visible light transmittance of the covering material 154 and/or a position of the hembar 158 may be adjusted based on a desired amount of light to allow into the room 102 through the window 104 proximate to the motorized window treatment 150. For example, the position of the hembar 158 may be adjusted by rotating the roller tube 152 until the hembar 158 is in a desired position (e.g., in which the hembar may be secured in a locked position). The desired position may be determined based on the desired amount of light to allow into the room 102 through the window 104, a desired amount of direct sunlight penetration into the room 102 (e.g., based on a position of the sun), and/or a privacy setting. For example, the user 142 may set the location of the hembar 158 for privacy and/or one or more view preferences. The one or more view preferences may be associated with one or more features (e.g., trees, parking lot, etc.) external to the room 102. The user may enter a desired light level for the room 102. The motorized window treatment 150 may adjust the visible light transmittance of the covering material 154 to adjust the amount of light in the room 102 (e.g., to maintain the desired light level for the room 102).

The covering material 154 of the motorized window treatment 150 may have a variable visible light transmittance. The covering material 154 may comprise multiple zones that may be controlled to different visible light transmittances. For example, the covering material 154 may comprise zones oriented horizontally across the width of the covering material 154 and/or vertically along the length of the covering material 154. In addition, the zones may be oriented in a grid (e.g., a grid of pixels) that may individually be controlled. The covering material 154 may comprise a liquid crystal display (LCD) material. The motorized window treatment 150 may be configured to adjust the visible light transmittance of the covering material 154 in response to the system controller 110, the mobile device 140, the remote control device 170, the inside sensor 180, and/or the outside sensor 182. The system controller 110, the mobile device 140, the remote control device 170, the inside sensor 180, and/or the outside sensor 182 may be configured to transmit messages including commands for controlling the motorized window treatment 150 to the motor drive unit 156 (e.g., directly and/or via the system controller). The commands may include a desired position to which to control the hembar 158 and/or a desired fabric characteristic for controlling the visible light transmittance of the covering material 154. For example, the commands may include a desired openness factor and/or a desired thickness for the covering material 154.

The motorized window treatment 150 may determine a present position of the covering material 154. The position may include a location of the hembar 158. Determining the position of the covering material 154 may include determining an amount of covering material 154 that is wrapped around the roller tube 152 of the motorized window treatment 150. When the covering material 154 includes a plurality of zones along a length of the covering material 154, the motorized window treatment 150 may determine which of the plurality of zones are unwrapped from the roller tube 152. The motorized window treatment 150 may be configured to control the zones that are unwrapped from the roller tube 152. The motorized window treatment 150 may be configured to control a visible light transmittance of the zones that are unwrapped from the roller tube 152, for example, by adjusting a thickness of the covering material 154 in the zones that are unwrapped. The thickness of the covering material 154 may be adjusted by applying heat and/or electricity to the covering material 154.

The covering material 154 of the motorized window treatment 150 may have a variable color and/or pattern. The motorized window treatment 150 may be configured to adjust the color and/or pattern of the covering material 154 in response to the system controller 110, the mobile device 140, the remote control device 170, the inside sensor 180, and/or the outside sensor 182. The system controller 110, the mobile device 140, the remote control device 170, the inside sensor 180, and/or the outside sensor 182 may be configured to transmit messages including triggers and/or commands for controlling the motorized window treatment 150 to the motor drive unit 156 (e.g., directly and/or via the system controller). The commands may include a desired position to which to control the hembar 158 and/or a desired fabric characteristic for controlling the color and/or pattern of the covering material 154. For example, the commands may include a color indicator, a color temperature, RGB levels, chromaticity coordinates, etc., for the desired color and/or an indicator for indicating a desired pattern. The indicator for indicating a desired pattern may be a pattern identifier. A pattern identifier may be a unique identifier for a specific pattern. For example, the covering material 154 may comprise a rollable or flexible display (e.g., an LED or OLED display). The motorized window treatment 150 may be configured to store a pattern as an image file that may be recalled using the pattern identifier included in a received command. The motorized window treatment 150 may include a video input (e.g., a video input port). The motorized window treatment 150 may be configured to display images on the flexible display received via the video input.

The covering material 154 of the motorized window treatment 150 may be a light-emitting fabric and may include integral light sources that may emit an amount of light. The light sources may be arranged in one or more zones on the covering material 154. For example, the zones of light sources may be oriented horizontally across the width of the covering material 154 and/or vertically along the length of the covering material 154. In addition, the zones of light sources may be oriented in a grid (e.g., a grid of pixels) that may individually be controlled. If the covering material 154 comprises a single zone, all of the light sources may be controlled in unison. For example, the light sources may comprise strings of LEDs arranged across the width of the covering material 154. In addition, the light sources may comprise optical fibers (e.g., fiberoptic elements) that extend along the width of the covering material and each have a respective light-emitting side (e.g., an exposed side) configured to emit light from the covering material 154. The optical fibers may be configured to conduct light from light sources in the roller tube 152 to the surface of the covering material 154. The light sources of the covering material 154 may be configured to emit light from an interior surface of the covering material 154 to shine light into the space and/or onto an exterior surface of the covering material 154. The light sources of the covering material 154 may be configured to emit light from an exterior surface of the covering material 154 to shine light into the space, onto a wall surrounding the window 104, the window, and/or onto the interior surface of the covering material 154.

The motorized window treatment 150 may be configured to adjust the intensity and/or color (e.g., color temperature) of the light emitted by the covering material 154 in response to the system controller 110, the mobile device 140, the remote control device 170, the inside sensor 180, and/or the outside sensor 182. The system controller 110, the mobile device 140, the remote control device 170, the inside sensor 180, and/or the outside sensor 182 may be configured to transmit messages including commands for controlling the motorized window treatment 150 to the motor drive unit 156 (e.g., directly and/or via the system controller). The commands may include a desired position to which to control the hembar 158 and/or a desired fabric characteristic for controlling the intensity and/or color of the light emitted by the covering material 154.

FIG. 1B is a diagram of an example load control system 100 for controlling one or more load control devices (e.g., similar to FIG. 1A). The control-target devices within the load control system 100 shown in FIG. 1B may comprise one or more daylight control devices, e.g., adjacent motorized window treatments 150a, 150b. The motorized window treatments 150a, 150b, each, may each comprise a respective roller tube 152a, 152b for controlling the amount of outside light (e.g., daylight) entering the room 102 through a window 104. The motorized window treatments 150a, 150b may each comprise respective covering materials, such as covering materials 154a, 154b. The covering materials 154a, 154b may be hanging in front of the window 104 and windingly received around the respective roller tube 152a, 152b. The roller tubes 152a, 152b may both be rotatably supported by mounting brackets 153 located at both ends of the roller tubes 152a, 152b.

The covering materials 154a, 154b may be characterized by variable visible light transmittance, thickness, color, pattern, style, etc. For example, the covering material 154a may be adjusted to have a warmer sheer color (e.g., as described above) that has changeable openness factor and/or color that allows a certain amount of outside light into the room. The covering material 154a may also, or alternatively, be adjusted to a cooler sheer color (e.g., as described above) that has changeable openness factor and/or color. The covering material 154b may be adjusted to have a blackout fabric that prevents outside light from entering the space 102. The blackout fabric may have a color and/or openness factor that prevents outside light from entering the space 102.

The motorized window treatments 150a, 150b may further comprise respective motor drive units 156a, 156b located inside of the respective roller tubes 152a, 152b. The motor drive units 156a, 156b may be configured to rotate the respective roller tubes 152a, 152b for raising and lowering the covering materials 154a, 154b to control the amount of outside light (e.g., daylight) entering the room 102. The motor drive units 156a, 156b of the motorized window treatments 150a, 150b may be configured to receive messages via the RF signals 108 (e.g., from the system controller 110 or a control-source device) and adjust the position of the respective covering material 154a, 154b in response to the received messages. The load control system 100 may comprise other types of daylight control devices, such as described above.

The motorized window treatments 150a, 150b may be controlled such that a hembar, or a bottom of the respective covering material 154a, 154b, is at a certain position (e.g., level) on the window 104. The motorized window treatments 150a, 150b may be controlled in response to messages from a control-source device (e.g., a button press on remote control 170, sensor information, etc.). The motorized window treatments 150a, 150b may be automatically controlled to a certain position (e.g., by the system controller 110, a control-source device, or another device in the system) based on a shade control mode (e.g., scene) and/or user preference. An example of an automated control system for motorized window treatments is described in greater detail in previously-referenced U.S. Pat. No. 8,786,236. One or more other example automated control systems for motorized window treatments may be implemented. The shade control mode and/or user preferences may be implemented by control parameters for providing the control mode and/or user preferences. For example, the position of each of the covering materials 154a, 154b may be controlled to a certain position based on the time of day, date, location of the building, location of the room 102 in the building, location of the window 104, weather, season, shadows, location of the occupant 142 in the room, location of the occupant's mobile device 140 in the room, occupancy/vacancy of the room 102, a location of a workspace 106 in the room 102, a view setting for allowing occupants to have an outside view, a privacy setting for allowing occupants to have privacy from the outside view, a glare setting for preventing daylight glare for an occupant within the space, characteristics of the covering material 154a, 154b (e.g., openness factor for allowing light into space, color, etc.), and/or the current position of the covering material 154a, 154b on the window.

The motorized window treatments 150a, 150b may also comprise one or more light sources for illuminating the covering materials 154a, 154b and/or the environment surrounding the motorized window treatments. For example, the covering material 154b may also include one or more light sources 160 (e.g., integral light sources), such as LED light sources, on the covering material 154b (e.g., directly disposed on the covering material), such that the covering material 154b is a light-emitting fabric. The motorized window treatments 150a, 150b may also comprise a light source 162, such as an LED light source, attached to, for example the mounting bracket 153. In addition, the motorized window treatments 150a, 150b may also comprise a light source (not shown) mounted on a hembar (not shown). For example, when the covering material 154a is a sheer fabric and the covering material 154b is a blackout fabric, both of the covering materials 154a, 154b may be closed and the exterior surface of the covering material 154a may be illuminated by the light sources 160 on the covering material 154b and/or the light source 162 on the mounting bracket 153 (e.g., to simulate natural light from a particular time of the day, such as sunrise or sunset).

The covering materials 154a, 154b of the motorized window treatments 150a, 150b may each have a variable visible light transmittance. The covering materials 154a, 154b may each comprise multiple zones that may be controlled to different visible light transmittances and/or opacities (e.g., in a similar manner as described above for the covering material 154). The motorized window treatment 150a may be configured to adjust the visible light transmittance of the covering material 154a and the motorized window treatment 150b may be configured to adjust the visible light transmittance of the covering material 154b (e.g., and vice versa). The motorized window treatments 150a, 150b may be configured to adjust the visible light transmittance of the respective covering materials 154a, 154b in response to the system controller 110, the mobile device 140, the remote control device 170, the inside sensor 180, and/or the outside sensor 182. The system controller 110, the mobile device 140, the remote control device 170, the inside sensor 180, and/or the outside sensor 182 may be configured to transmit messages including commands for controlling the motorized window treatments 150a, 150b to the respective motor drive units 156a, 156b (e.g., directly and/or via the system controller). The commands may include a desired position to which to control the respective covering material 154a, 154b and/or a desired fabric characteristic for controlling the visible light transmittance of the respective covering material 154a, 154b.

The covering materials 154a, 154b of the motorized window treatments 150a, 150b may each have a variable color and/or pattern (e.g., in a similar manner as described above for the covering material 154). Each motorized window treatments 150a, 150b may be configured to adjust the color and/or pattern of the respective covering material 154a, 154b in response to the system controller 110, the mobile device 140, the remote control device 170, the inside sensor 180, and/or the outside sensor 182. The system controller 110, the mobile device 140, the remote control device 170, the inside sensor 180, and/or the outside sensor 182 may be configured to transmit messages including commands for controlling the motorized window treatments 150a, 150a to the respective motor drive units 156a, 156b (e.g., directly and/or via the system controller). The commands may include a desired position to which to control the respective covering material 154a, 154b and/or a desired fabric characteristic for controlling the color and/or pattern of the respective covering material 154a, 154b. In addition, the motorized window treatments 150a, 150b may operate in conjunction with each other to adjust the color of the covering material 154a of the motorized window treatment 150a. For example, the covering material 154a of the motorized window treatment 150a may be white, and the motorized window treatment 150b may control the color of the light emitted by the light sources 160 on the covering material 154b to control the color of the covering material 154a of the motorized window treatment 150a.

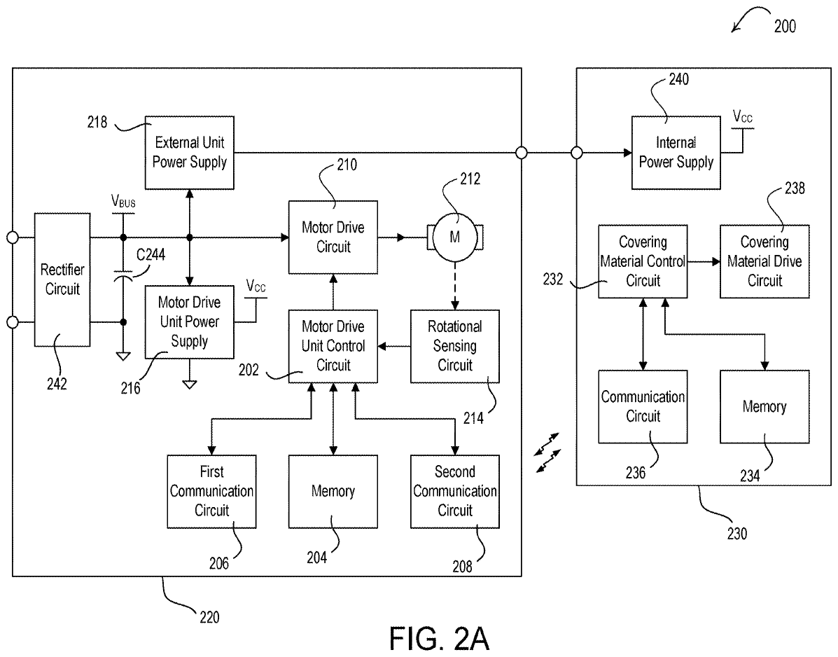

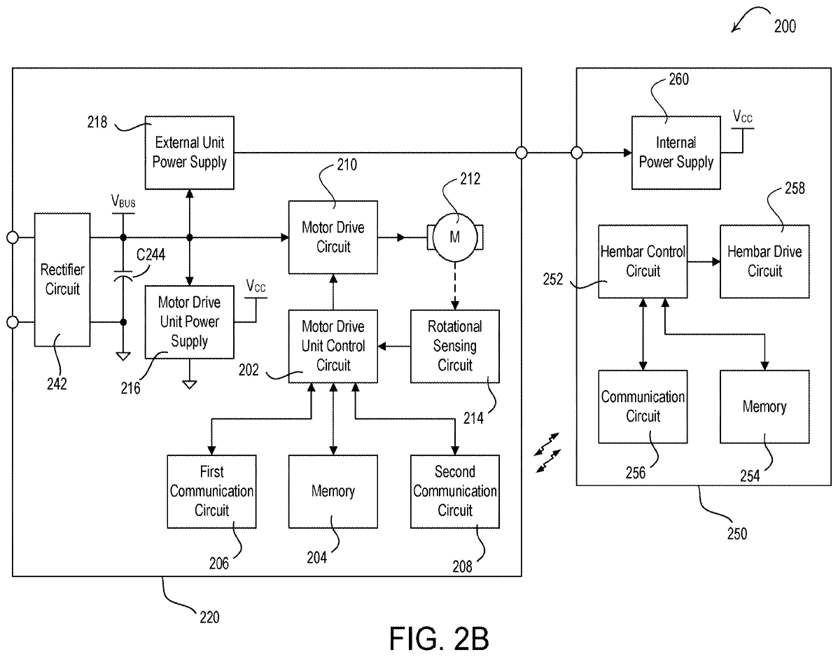

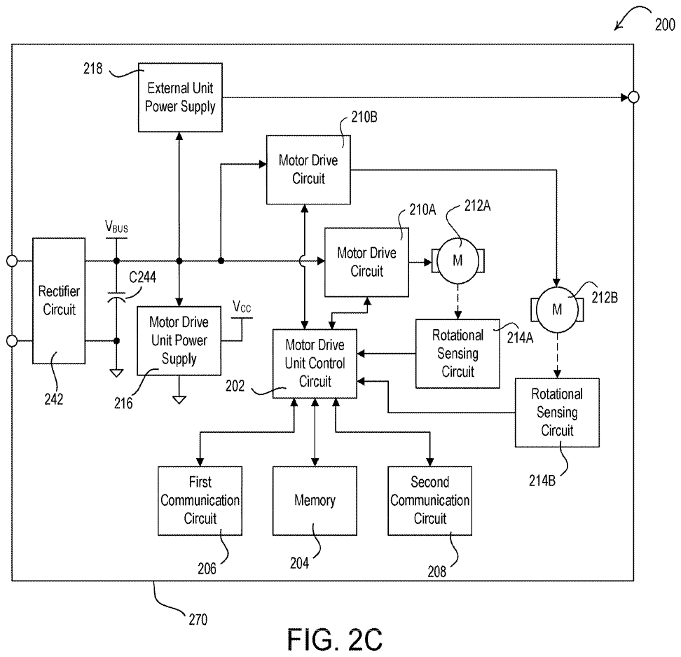

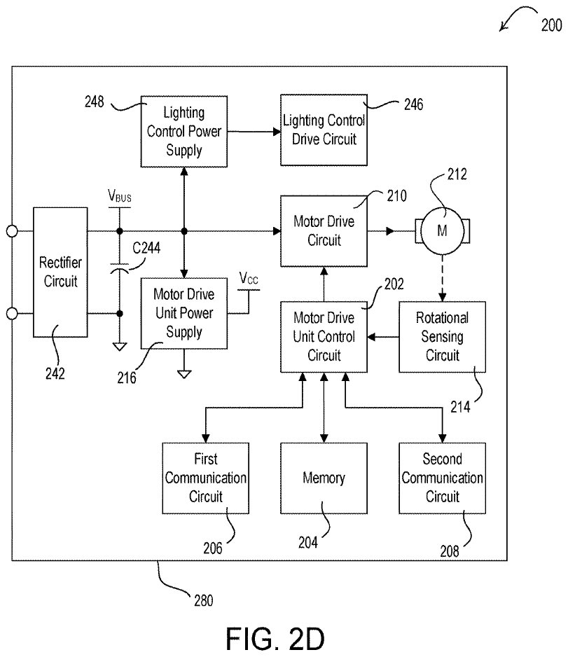

FIGS. 2A-2D illustrate block diagrams illustrating an example motorized window treatment 200 (e.g., the motorized window treatments 150, 150a, 150b). As shown in FIG. 2A, the motorized window treatment 200 may include a motor drive unit 220 (e.g., the motor drive units 156, 156a, 156b) and a covering material control unit 230. The motor drive unit 220 may be installed inside of a roller tube (e.g., the roller tubes 152, 152a, 152b) of the motorized window treatment 200 for rotating the roller tube to raise and lower a covering material (e.g., the covering materials 154, 154a, 154b). The covering material control unit 230 may be mounted to and/or integrated into the roller tube of the motorized window treatment 200.

The motor drive unit 220 may include a motor drive unit control circuit 202 for controlling the functionality of the motorized window treatment 200. The motor drive unit control circuit 202 may include one or more general purpose processors, special purpose processors, conventional processors, digital signal processors (DSPs), microprocessors, integrated circuits, a programmable logic device (PLD), application specific integrated circuits (ASICs), or the like. The motor drive unit control circuit 202 may perform signal coding, data processing, image processing, power control, input/output processing, motor control processing, and/or any other functionality that enables the motorized window treatment 200 to perform as described herein.

The motor drive unit control circuit 202 may store information in and/or retrieve information from a memory 204. The memory 204 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory 204 may be an integrated circuit external to the motor drive unit control circuit 202 and/or an integral circuit of the motor drive unit control circuit 202.

The motor drive unit 220 may include a first communication circuit 206 for transmitting and/or receiving information. The first communication circuits 206 may perform wireless and/or wired communications. The motor drive unit control circuit 202 may also include a second communication circuit 208 for transmitting and/or receiving information. The second communication circuit 208 may perform wireless and/or wired communications. The communication circuits 206, 208 may be in communication with the motor drive unit control circuit 202. The communication circuits 206, 208 may include RF transceivers or other communications circuits capable of performing wireless communications via an antenna. The communication circuits 206, 208 may be capable of performing communications via the same communication channels or different communication channels. For example, the first communication circuit 206 may be capable of communicating (e.g., with control devices and/or other devices in the load control system) via a first wireless communication link (e.g., a wireless network communication link) and/or communicating using a first wireless protocol (e.g., a wireless network communication protocol, such as the CLEAR CONNECT and/or THREAD protocols). The second communication circuit 208 may be capable of communicating (e.g., with the roller tube unit, etc.) via a second wireless communication link (e.g., a short-range wireless communication link) and/or communicating using a second wireless protocol (e.g., a short-range wireless communication protocol, such as the BLUETOOTH and/or BLUETOOTH LOW ENERGY (BLE) protocols).

The motor drive unit 220 may comprise a motor drive circuit 210 for driving a motor 212 to rotate the roller tube. The motor drive unit 220 may also comprise a rotational sensing circuit 214 (e.g., a Hall-effect sensing circuit). The motor drive control circuit 202 may be configured to determine an amount of rotation and/or a direction of rotation of the roller tube in response to the rotational sensing circuit 214 for determining a position of the covering material. The motor drive control circuit 202 may be configured to control the motor drive circuit 210 to rotate the roller tube in response to the rotational sensing circuit 214. For example, the motor drive control circuit 202 may be configured to determine how much of the covering material is wrapped around the roller tube in response to the position of covering material determined from the rotational sensing circuit 214.

Each of the circuits within the motor drive unit 220 (e.g., the motor drive control circuit 202, the memory 204, the first communication circuit 206, the second communication circuit 208, and/or the rotational position sensing circuit 214) may be powered by a motor drive unit power supply 216. The motor drive unit power supply 216 may receive power from an external alternating-current (AC) power source or direct-current (DC) power source, for example. The motor drive unit power supply 216 may generate a supply voltage VCC for powering the circuits of the motor drive unit 220. The motor drive unit 220 may comprise a rectifier circuit 242 for generating a DC bus voltage V_{BUS} across a storage capacitor C244 (e.g., when the motor drive unit 200 is powered by an AC power source. When the motor drive unit 200 is powered by a DC power source, the rectifier circuit 242 may be omitted. The motor drive circuit 210 and the motor drive unit power supply 216 may receive the bus voltage V_{BUS}.

The motor drive unit 220 may further comprise an external unit power supply 218 for powering the covering material control unit 230. The external unit power supply 218 may also receive the bus voltage V_{BUS}. For example, the external unit power supply 218 may power the covering material control unit 230 via an electrical connection, magnetic coupling, etc.

The covering material control unit 230 may include a covering material control circuit 232 for controlling the functionality of the covering material (e.g., the visible light transmittance and/or the color of the covering material). The covering material control circuit 232 may include one or more general purpose processors, special purpose processors, conventional processors, digital signal processors (DSPs), microprocessors, integrated circuits, a programmable logic device (PLD), application specific integrated circuits (ASICs), or the like. The covering material control circuit 232 may perform signal coding, data processing, image processing, power control, input/output processing, covering material processing, and/or any other functionality that enables the motorized window treatment 200 to perform as described herein.

The covering material control circuit 232 may store information in and/or retrieve information from a memory 234. The memory 234 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory 234 may be an integrated circuit external to the covering material unit control circuit 232 and/or an integral circuit of the covering material unit control circuit 232.

The covering material control unit 230 may include a communication circuit 236 for transmitting and/or receiving information. The communication circuit 236 may perform wireless and/or wired communications. The communication circuit 236 may include RF transceivers or other communications circuits capable of performing wireless communications via an antenna. The communication circuit 236 may be capable of communicating (e.g., with the motor drive unit, etc.) via a wireless communication channel (e.g., BLUETOOTH®, near field communication (NFC), WIFI®, magnetic induction, etc.). For example, the covering material control circuit 232 may be configured to receive, via the communication circuit 236, a message including a command for controlling the covering material. The command may include a desired visible light transmittance of the covering material, a desired openness factor of the covering material, a desired thickness of the covering material, a desired color and/or pattern of the covering material, and/or a desired light intensity of light to be emitted by the covering material.

The covering material control circuit 232 may be in communication with a covering material drive circuit 238 for driving the fabric, conduct a current through one or more zones of the covering material, apply heat to one or more zones of the covering material, control one or more LCD zones of the covering material, adjust a color of the covering material, adjust a pattern of the covering material, control one or more light sources within the covering material, and/or illuminate fiber optics. For example, the covering material drive circuit 238 may conduct a current through and/or apply heat to the one or more zones to adjust a thickness of the covering material. The covering material drive circuit 238 may send one or more commands to control the covering material such that the color and/or pattern of the covering material is changed. The covering material drive circuit 238 may illuminate fiber optics to change and/or illuminate the covering material. The covering material drive circuit 238 may include a display driver (not shown) if the fabric has an LCD screen, a fiberoptic drive circuit, etc.

The covering material control unit 230 may be powered by an internal power supply 240. As described herein, the internal power supply 240 of the covering material control unit 230 may receive power from the motor drive unit 220 (e.g., from the external unit power supply 218). Additionally or alternatively, the covering material control unit 230 may be battery-powered. For example, the covering material control unit 230 may include one or more batteries for powering the covering material control circuit 232, the memory 234, the communication circuit 236, and/or the covering material drive circuit 238.

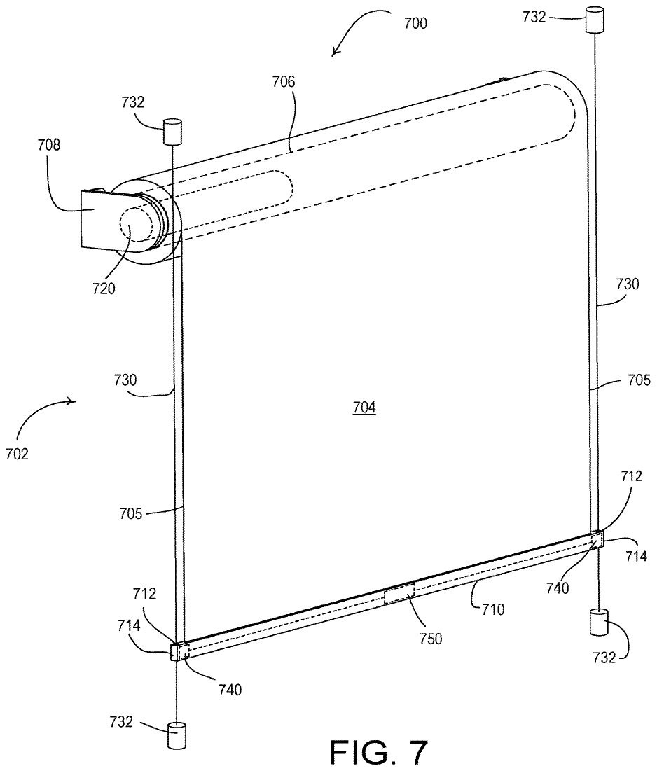

As shown in FIG. 2B, the motorized window treatment 200 may include a hembar control unit 250 (e.g., such as the hembar control unit 750 shown in FIG. 7). The hembar control unit 250 may be mounted to and/or integrated into the hembar of the motorized window treatment 200. The external unit power supply 218 may power the hembar control unit 250 via an electrical connection, magnetic coupling, etc.

The hembar control unit 250 may include a hembar control circuit 252 for controlling the functionality of one or more clamping mechanisms (e.g., such as the clamping mechanisms 740 shown in FIG. 7) mounted to or within the hembar. The hembar control circuit 252 may include one or more general purpose processors, special purpose processors, conventional processors, digital signal processors (DSPs), microprocessors, integrated circuits, a programmable logic device (PLD), application specific integrated circuits (ASICs), or the like. The hembar control circuit 252 may perform signal coding, data processing, image processing, power control, input/output processing, clamping mechanism processing, and/or any other functionality that enables the motorized window treatment 200 to perform as described herein.

The hembar control circuit 252 may store information in and/or retrieve information from a memory 254. The memory 234 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory 254 may be an integrated circuit external to the hembar control circuit 252 and/or an integral circuit of the hembar control circuit 252.

The hembar control unit 250 may include a communication circuit 256 for transmitting and/or receiving information. The communication circuit 256 may perform wireless and/or wired communications. The communication circuit 256 may include RF transceivers or other communications circuits capable of performing wireless communications via an antenna. The communication circuit 256 may be capable of communicating (e.g., with the motor drive unit, etc.) via a wireless communication channel (e.g., BLUETOOTH®, near field communication (NFC), WIFI®, magnetic induction, etc.). For example, the hembar control circuit 252 may be configured to receive, via the communication circuit 256, a message including a command for controlling the clamping mechanisms. The command may include a desired hembar location, a desired amount of covering material to be unwrapped from the roller tube, and/or a desired visible light transmittance (e.g., a desired openness factor).

The covering material control circuit 252 may be in communication with a hembar drive circuit 258 for driving the controlling the clamping mechanisms. For example, the hembar drive circuit 258 may send one or more commands to control the clamping mechanisms such that the desired hembar location, the desired amount of covering material to be unwrapped from the roller tube, and/or the desired visible light transmittance (e.g., a desired openness factor) is achieved. The hembar drive circuit 258 may include a display driver (not shown) if the fabric has an LCD screen, a fiberoptic drive circuit, etc.

The hembar control unit 250 may be powered by an internal power supply 260. As described herein, the internal power supply 260 of the hembar control unit 250 may receive power from the motor drive unit 220 (e.g., from the external unit power supply 218). For example, one or more power lines may extend through and/or may be attached to the covering material between the roller tube and the hembar to power the internal power supply 260. Additionally or alternatively, the hembar control unit 250 may be battery-powered. For example, the hembar control unit 250 may include one or more batteries for powering the hembar control circuit 252, the memory 254, the communication circuit 256, and/or the covering material drive circuit 258.

As shown in FIG. 2C, a motor drive unit 270 (e.g., such as the motor drive unit 220 shown in FIGS. 2A and 2B) of the motorized window treatment 200 may include a plurality of motor drive circuits 210A, 210B, a plurality of motors 212A, 212B, and a plurality of rotational sensing circuits 214A, 214B. The motor drive circuit 210A may be configured to drive motor 212A to rotate the roller tube of the motorized window treatment 200. The motor drive circuit 210B may be configured to drive motor 212B to rotate one or more spools such that one or more tilt cords (e.g., such as the tilt cord 940 shown in FIG. 10) winding received by the spools are raised and lowered. For example, rotation of the motor 212B may be configured to adjust a visible light transmittance of the covering material by adjusting a position of one or more vanes (e.g., such as the adjustable vanes 924) attached to the tilt cord.

The rotational sensing circuits 214A, 214B may be a Hall-effect sensing circuits. The motor drive control circuit 202 may be configured to determine an amount of rotation and/or a direction of rotation of the roller tube in response to the rotational sensing circuit 214A for determining a position of the covering material. The motor drive control circuit 202 may be configured to control the motor drive circuit 210A to rotate the roller tube in response to the rotational sensing circuit 214A. For example, the motor drive control circuit 202 may be configured to determine how much of the covering material is wrapped around the roller tube in response to the position of covering material determined from the rotational sensing circuit 214A.

The motor drive control circuit 202 may be configured to determine an amount of rotation and/or a direction of rotation of the spool(s) in response to the rotational sensing circuit 214B for determining a position of the vanes of the covering material. The motor drive control circuit 202 may be configured to control the motor drive circuit 210B to rotate the spool(s) in response to the rotational sensing circuit 214B. For example, the motor drive control circuit 202 may be configured to determine how much of the tilt cord is wrapped around the roller tube and/or a position of the vanes of the covering material in response to the position of the vanes of the covering material determined from the rotational sensing circuit 214B.

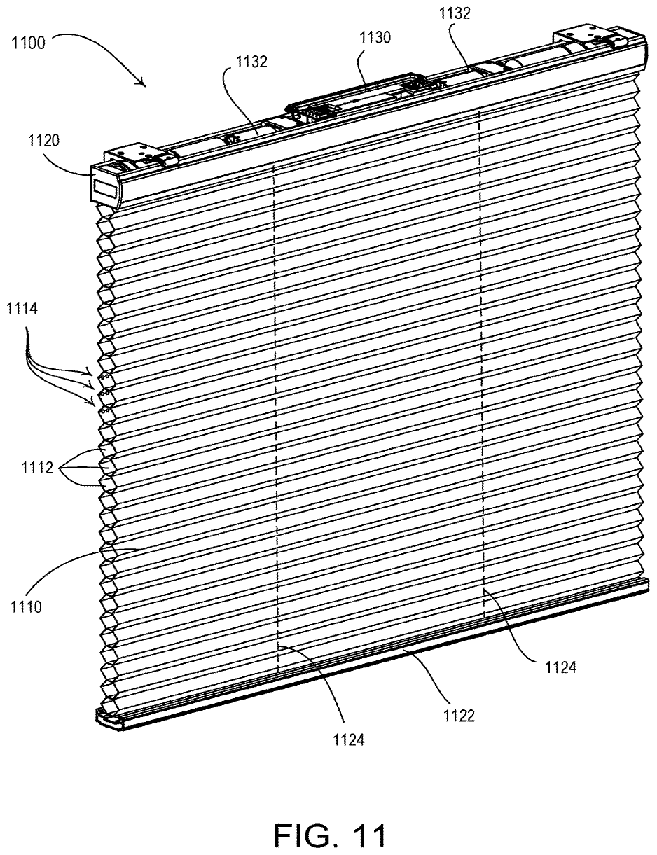

As shown in FIG. 2D, a motor drive unit 280 (e.g., such as the motor drive unit 220 shown in FIGS. 2A and 2B) of the motorized window treatment 200 may include a lighting control drive circuit 246 and a lighting control power supply 248. The lighting control drive circuit 246 may be powered by the lighting control power supply 248. The lighting control drive circuit 246 may be configured to control an intensity and/or a color of one or more light sources (e.g., such as the light sources 1114 shown in FIG. 11) that are attached to and/or integrated into the covering material. For example, the lighting control drive circuit 246 may individually control an amount of power delivered to and/or the luminous flux of the light emitted by each of the light sources. The lighting control drive circuit 246 may receive a bus voltage V_{BUS} from the lighting control power supply 248 and may adjust magnitudes of respective drive currents conducted through the light sources. The lighting control drive circuit 246 may include one or more regulation circuits, such as switching regulators (e.g., buck converters) for controlling the magnitudes of the respective drive currents.

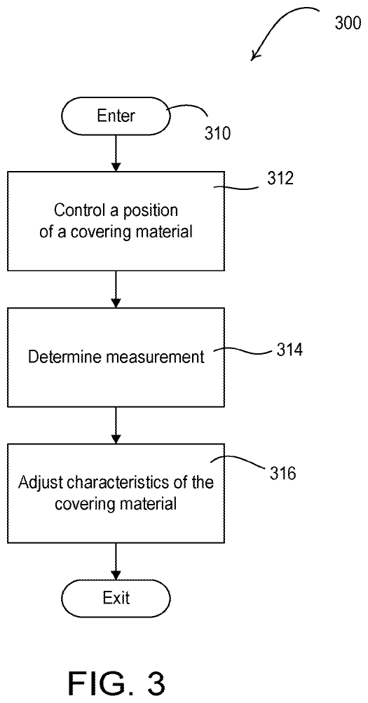

FIG. 3 is a flowchart of an example process 300 for controlling a motorized window treatment. The process 300 may be performed at a single device or distributed across multiple devices. For example, the process 300 may be performed at a load control device (e.g., such as a motorized window treatment), a system controller, a mobile user device, a sensor, and/or another computing device. Though the process 300 may be described with reference to a certain device, such as the motorized window treatment, one or more other devices in the load control system may be implemented to perform similar functionality. For example, information may be provided to a system controller or another control device for making determinations on performing control of the covering material(s) of a motorized window treatment and control instructions for performing such control may be communicated to the motorized window treatment.

As shown in FIG. 3, the process 300 may begin at 310. At 312, a position of a covering material on a motorized window treatment may be controlled depending upon a control mode and/or user preference. The control mode may be implemented using user preferences and/or commands. The control mode may implement by one or more control parameters, for example, to achieve the user preferences and/or implement the commands. For example, the covering material may be controlled to a certain position based on the time of day, date, location of the building, location of the room in the building, location of the window, weather, season, shadows, location of the occupant, location of the occupant's mobile device, occupancy/vacancy of the room, a location of a workspace in the room, a view setting for allowing occupants to have an outside view, a privacy setting for allowing occupants to have privacy from the outside view, a glare setting for preventing daylight glare for an occupant within the space, and/or the position of the covering material on the window. The covering material may be opened and closed according to the control parameters of the control mode or the user preferences to allow for outside light to enter the space or allow the occupant to have an outside view.

After controlling the position of the covering material, one or more sensors (e.g., the inside sensor 180, the outside sensor 182, etc.) may perform and/or provide measurements of the space. For example, the sensors may measure the amount of light entering the space, the amount of light inside the space, the amount of light outside of the space, etc., at 314. The sensors may send the measurements of the space to the control circuit, such as the motorized window treatment 200, and the control circuit of the motorized window treatment 200 may determine/adjust one or more characteristics of the covering material at 316.

At 316, one or more characteristics of the covering material may be adjusted via the control circuit (e.g., of the motorized window treatment 200). As described herein, the characteristics of the covering material may include visible light transmittance (e.g., such as openness factor, thickness, etc.), color, pattern, etc. Based on the measurement of the space, the control circuit may adjust the visible light transmittance of the covering material (e.g., by adjusting the openness factor of the covering material) to allow daylight to enter and/or limit the amount of daylight entering the space. Based on the measurement, the control circuit may determine to adjust the covering material between a transparent state, a translucent state, and/or an opaque state (e.g., a blackout state). Based on the measurement, the control circuit may adjust color and/or pattern of the covering material to allow daylight to enter or limit the amount of daylight entering the space. For example, the control circuit may adjust the color and/or pattern of the covering material by adjusting to darker or lighter color/pattern based on the measurement in 314. The control circuit may be configured to control different zones (e.g., horizontal zones, vertical zones, and/or zones oriented in a grid) in different manners based on the measurement of the space.

Alternatively or additionally, based on the measurement, the control circuit may adjust intensities of the light sources (e.g., integral light sources such as LEDs) that are on or proximate to the covering material. For example, the light sources on/proximate to the covering material may emit light and shine light into the space based on the measurement. The intensities of the light sources may be adjusted to allow the light entering the space or limit the amount of light entering the space.

By adjusting the characteristics of the covering material (e.g., via the control circuit of the motorized window treatment 200), the covering material may have variable visible light transmittance and may change the amount of light entering the space. For example, the visible light transmittance of the covering material may be adjusted (e.g., higher or lower) by the motorized window treatment. The visible light transmittance of the covering material may be adjusted by changing the openness factor of the covering material. The openness factor may be increased by stretching the covering material by pulling the covering material in an opposite direction. The openness factor may be decreased by constraining the covering material by pulling the covering material in the same direction. Alternatively or additionally, the openness factor may be increased by constraining the covering material by pulling the covering material in the same direction, or the openness factor may be decreased by stretching the covering material by pulling the covering material in the opposite direction. The openness factor of the covering material may be increased and/or decreased by heating the fabric. For example, the openness factor of the covering material may be increased by heating the fabric to expand and decreased by cooling the fabric to contract. The covering material may be heated by conducting current through electrical wires that run through regions of the fabric.

The control circuit may adjust the covering material to control the covering material between a transparent state, a translucent state, and/or an opaque (e.g., blackout) state. In the transparent state, the covering material may allow natural light (e.g., as much natural light as possible) to enter the space through the covering material. The user may have a clear view of the outside and privacy may be limited. In the translucent state, the covering material may allow daylight into the space. The covering material may be adjusted to limit the amount of natural light entering the space through the covering material. The user may have a varying view of the outside and may have a varying amount of privacy as the transparency and/or translucency of the shade changes. In the opaque state, the covering material may prevent daylight (e.g., 0% natural light) from entering the space (e.g., blocking light from the outside). The user may have a complete privacy and may be unable to see outside.

The control circuit of the motorized window treatment may adjust the fabric characteristics by changing the intensities of light sources, such as LEDs, on or in proximity to the covering material. For example, the covering material may include the LEDs on the fabric shade itself (e.g., as shown in FIG. 1B) and/or proximate to the fabric (e.g., in the hembar or on the mounting bracket as shown in FIG. 1B). The LEDs may be turned on/off or the intensities may be changed to control the light entering the space. The LEDs may also be adjusted to provide a source of light to the space (e.g., an additional or alternative lighting source, such as the lamp, downlight, etc.).

The characteristics of covering material may be adjusted, e.g., via the control circuit of the motorized window treatment, to change color, pattern, and/or style of the covering material. The color, pattern, and/or style of the covering material may be adjusted to control the amount of light entering the space.

A motorized window treatment may be configured to adjust a visible light transmittance, a color, and/or a lighting configuration of a covering material of the motorized window treatment. For example, the motorized window treatment may be configured to determine a present visible light transmittance, a present color, and/or a present lighting configuration of the covering material. The motorized window treatment may adjust the covering material to a target visible light transmittance, a target color, and/or a target lighting configuration, for example, based on a trigger. The trigger may be a command (e.g., that indicates that the motorized window treatment should adjust the covering material). For example, the motorized window treatment may receive a trigger. The trigger may indicate the target visible light transmittance, the target color, the target thickness, and/or the target lighting configuration.

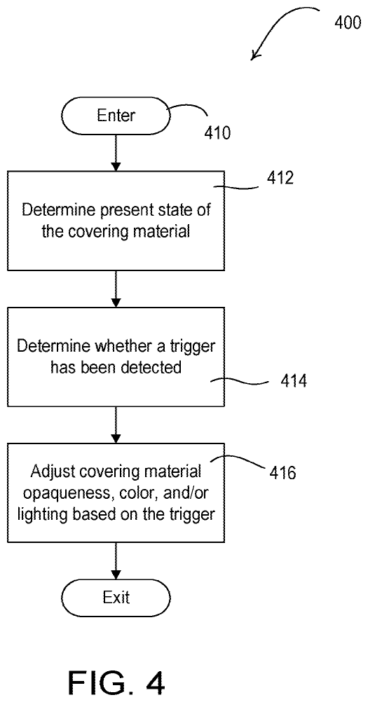

FIG. 4 is a flowchart of an example process 400 for controlling a motorized window treatment. The process 400 may be performed at a single device or distributed across multiple devices. For example, the process 400 may be performed at a load control device (e.g., such as a motorized window treatment), a system controller, a mobile user device, a sensor, and/or another computing device. Though the process 400 may be described with reference to a certain device, such as the motorized window treatment, one or more other devices in the load control system may be implemented to perform similar functionality. For example, information may be provided to a system controller or another control device for making determinations on performing control of the covering material(s) of a motorized window treatment and control instructions for performing such control may be communicated to the motorized window treatment

As shown in FIG. 4, the process 400 may begin at 410. At 412, the present state of a motorized window treatment with covering material may be determined. For example, the present state of the characteristics of the covering material may include a visible light transmittance (e.g., such as an openness factor, a thickness, etc.), a color, a pattern, intensities of light sources, such as LEDs, etc. The motorized window treatment 200 may retrieve information about the present state of the fabric characteristics of the covering material from the memory.

At 414, the motorized window treatment may determine whether one or more triggers have been detected. The one or more triggers may be related to a time (e.g., each day at the same time), a time of day, such as related to sunset or sunrise (e.g., each day before, after, or at sunset/sunrise), an actuation of a button by the user (e.g., via a mobile device application or a remote control), as a part of a scene, an alarm clock/event, based on the light inside of the space and/or the light outside of the space, occupancy of the space, a hand swipe of the user detected on or proximate to the window shade, a connection with other devices (e.g., a television, an alarm, etc.), and/or the like.

At 416, if the motorized window treatment determines that one or more triggers have been detected, the control circuit of the motorized window treatment may adjust the characteristics of the covering material. For example, the motorized window treatment may adjust the visible light transmittance, color, pattern, intensities of the light sources, and/or other characteristic of the covering material. As described herein, the covering material may be adjusted to allow more natural sunlight to enter the space or limit the amount of natural sunlight entering the space. The motorized window treatment may determine whether to adjust the characteristics of the covering material based on the determined present state of the covering material and the trigger. For example, if the motorized window treatment determines that the present state of the covering material is the same as a trigger event to adjust the characteristics of the covering material, the motorized window treatment may maintain the characteristics of the covering material. For example, if the motorized window treatment determines that the present state of the covering material in a transparent state and receives a trigger event to adjust the characteristics of the covering material to be in the transparent state, the motorized window treatment may maintain the present state of the covering material and may keep the characteristics of the covering material.

As an example, the characteristics of the covering material may have variable visible light transmittance. The control circuit may adjust the visible light transmittance of the covering material based on an alarm set by the user (e.g., a triggering event). For example, when the user sets the alarm, the motorized window treatment may receive the input from the alarm, e.g., via the first communication circuit. For example, the input from the alarm to the motorized window treatment may be a time (e.g., associated with a local timeclock) and/or an indication that a timer (e.g., such as the alarm) has started. At a preconfigured time before the alarm goes off (e.g., ten minutes before the alarm goes off), the motorized window treatment may start transitioning the covering material from a blackout state to a translucent state. For example, the motor drive unit control circuit 202 may communicate with the covering material control circuit 232 to gradually adjust the openness factor of the covering material and allow the natural light to enter the space.

When the alarm goes off, the covering material may be in the translucent state and allow the natural light (e.g., as much natural light as possible) into the space. The user may be awakened by the natural light entering the room when the alarm goes off. The covering material may transition to the translucent state over a period of time prior to the alarm going off.

As an example, the motorized window treatment may adjust the visible light transmittance of the covering material when the user goes to bed or when the sun sets. For example, the control circuit of the motorized window treatment may adjust the covering material from the transparent state or the translucent state to the blackout state based on the local sunset time (e.g., based on an astronomical timeclock). The motorized window treatment may communicate (e.g., via the first communication circuit) with a mobile device and/or a weather information data source (e.g., remote database on a computing device) to determine the local sunset time and control the motor drive unit control circuit 202 and/or the roller tube control circuit 232 to adjust the covering material. The user may actuate a button (e.g., on a remote control or on an application of the mobile device to cause a triggering event), and the motorized window treatment may adjust the covering material to transition from the translucent or the transparent state to the blackout state before going to the bed. As described above, the blackout state may block the light entering the space and provide privacy. The covering material may be in the blackout state throughout the night, and the characteristics of the covering material may change when a trigger (e.g., the set alarm time as described above) is detected.

As an example, the motorized window treatment may adjust the visible light transmittance of the covering material when the user watches a television during a bright day (e.g., to reduce daylight glare). The user may actuate the button on the remote control or on an application of the mobile device (e.g., to cause a triggering event). The actuation of the button by the user may be transmitted to the motor drive unit control circuit (e.g., via the first communication circuit 206 directly or indirectly via an intermediary device, such as the system controller or the television itself), and the motor drive unit control circuit 202 may communicate with the motor drive circuit 210 and/or the covering material control circuit 232 to change the visible light transmittance of the covering material to limit the natural light entering the space (e.g., to provide optimal viewing experience by reducing the daylight glare on the television screen). For example, on warm and bright days, the covering material may be closed and be in a translucent state to control the light entering the space (e.g., letting natural light in) and/or help control heat gain. If the user wants to watch the television, the user may adjust the covering material to reduce the visible light transmittance in the translucent state or transition from the translucent state to a blackout state.

The control circuit of the motorized window treatment, or another device in the system, may detect the user turning on the television (e.g., via communicating directly with the television, based on receiving the signal for turning on the television, or otherwise receiving a signal indicating the television has been turned on). Based on the control circuit detecting the user turning on the television and a sensor measurement (e.g., the inside sensor indicating that the room is too bright), the control circuit may adjust the visible light transmittance of the covering material automatically. The user may save the current setting of the space (e.g., the visible light transmittance of the covering material, the television being on, and/or the brightness of the space) for being recalled when similar environmental settings are detected. For example, the user may actuate a button (e.g., on the remote control, on the app of the mobile device, and/or the like) and save the current setting in the memory, and the motorized window treatment or other device, such as a system controller, may retrieve the current setting (e.g., from the memory) at a later time.

One or more light sources, such as the LEDs, may be installed on the covering material or proximate to the covering material (e.g., on the hembar or on the mounting bracket), as illustrated in FIG. 1B. As an example, the user may set an alarm (e.g., a triggering event) and may need to wake up when it is still dark outside. At a preconfigured time before the alarm goes off (e.g., ten minutes before the alarm goes off), the control circuit of the motorized window treatment, such as the motorized window treatment 200, may configure the LEDs on or proximate to the covering material to start emitting light. The control circuit may control the LEDs to gradually increase in intensity as the set time approaches. When the alarm goes off, the LEDs on or proximate to the covering material may be fully lit. In an example, the light intensity and/or color temperature of the LEDs may imitate the natural morning light (e.g., even though it may be dark outside). The LEDs on or proximate to the covering material may provide the lighting to the space and may also provide the privacy to the user as the shades are still down.

As an example, the LEDs on or proximate to the covering material may be used to imitate the natural light. When the sun sets early (e.g., on or before 5 PM), the user may close the shades. While the shades are down, the LEDs on or proximate to the covering material may begin emitting light and imitate natural light. For example, when the user returns to home and it is typically dark outside, the LEDs on or proximate to the covering material may be adjusted to imitate the intensity and/or color of natural light (e.g., at another time of day). The user may still enjoy natural light-like environment.

The control circuit may change the intensities and/or color temperature of the LEDs to have a later sunset time (e.g., 8 PM well after the actual sun is set) and may enjoy an imitation of longer daylight. The control circuit may gradually decrease the intensities and/or color temperature of the LEDs to imitate the sunset. The LEDs on or proximate to the covering material may be off, and the user may use standard electric lights to illuminate the room. Electric wires may run between the LEDs from a power source. The motorized window treatment (e.g., the control circuit of the motorized window treatment) may increase/decrease electrical power to the power source of the LEDs and control intensity and/or color temperature of the LEDs.

As described herein, the LEDs on or proximate to the covering material may be scheduled to imitate the sunset and sunrise. The scheduled LEDs on or proximate to the covering material may expose the user with the natural light-like intensities color temperature when the natural sun light is limited (e.g., due to weather or season).

As an example, the LEDs on or proximate to the covering material may provide safety and security to the user. When the user closes the shades around the sunset for privacy and/or when it may be dark outside, the motorized window treatment may increase the intensities of the LEDs and emit light outside of the space (e.g., toward outside of the house). By brightening the exterior of the window shade, the LEDs on or proximate to the covering material may simulate interior lights being on in the home and enhance security after the sunset and through the night. The brightness intensities and/or the color temperatures of the LEDs may be adjusted based on the user actuating the button on the remote control and/or on the application of the mobile device. The brightness intensities and/or the color temperatures of the LEDs may be adjusted based on the ambient light condition of the outside of the house.

The user may control (e.g., turn on/off) the LEDs on or proximate to the covering material when the user is away from the house and provide security. For example, the user may actuate the button on the remote control and/or on the application of the mobile device to control the intensities of one or more LEDs on or proximate to the covering material of the spaces to be on or off to simulate occupancy and movement in the house while the user is away. Alternatively, or additionally, the user may set up scheduled event to turn on/off the LEDs on or proximate to the covering material of the spaces to simulate occupancy and movement in the house while the user is away.

As an example, the LEDs on or proximate to the covering material may be adjusted during the time of day. During the day, the shades may be open and allow the natural light to enter the space. At night, the shades may be closed for privacy. The user may adjust intensities on the LEDs on or proximate to the covering material (e.g., rather than turning on lamps, downlights, and/or the like), providing a bright luminous vertical surface (e.g., washing the walls with lights for decorative purposes), and provide the light for the space. The LEDs on or proximate to the covering material may adjust the light intensity and/or the color temperature of the LEDs and may change the brightness and/or the color of the space may be adjusted. As described herein, the intensities and/or color temperature of the LEDs may be adjusted based on one or more triggering events, such as the level of brightness/darkness of the room. For example, the intensities and/or color temperature of the LEDs on or proximate to the covering material may be triggered to increase intensities and/or color temperatures (e.g., to illuminate the space) when the darkness of the space reaches a triggering point (e.g., a triggering event). The intensities and/or color temperature of the LEDs on or proximate to the covering material may also be triggered to adjust intensities and/or color temperatures when the shade is closed and/or based on the evening schedule of the user (e.g., other triggering event, such as sunset time, and/or the like).

As an example, the LEDs on or proximate to the covering material may be used as a night light. For example, the user may actuate a button on the remote control and/or on the app of the mobile device to trigger the LEDs to provide a soft glow night light in a child's bedroom through the night.

Alternatively, or additionally, the LEDs on or proximate to the covering material may also be triggered to adjust the intensities of the LEDs to provide light throughout the house and help the user to navigate around the house during the night when lights are usually off. Alternatively, or additionally, the occupancy sensor may sense presence of the user based on the time of day (e.g., conditional occupancy sensing based on time of day). For example during the day, the occupancy sensor may adjust the intensities of the LEDs based on sensing occupancy (e.g., increasing the intensities of the LEDs or turning the LEDs on when detecting occupancy and decreasing the intensities of the LEDs or turning the LEDs off when detecting vacancy). At night, the occupancy sensor may be turned off and the LEDs on or proximate to the covering material may be adjusted to have a warm and dim level for navigation around the house.

Similarly, as described herein, the characteristics of the covering material may change color, pattern, and/or style to allow or limit light entering the space. As an example, when the user selects the covering material, the user may select the color-and pattern-changing fabrics (e.g., rather than selecting and committing to the fabric color and/or style). If the user selects and installs the color-and pattern-changing covering material, the user may adjust the color and/or pattern of the covering material with the actuation of the button on the remote control, the application on the mobile device, and/or the like. Alternatively, or additionally, the user may swipe the covering material and/or proximity to the covering material to change the color and/or pattern of the covering material. For example, the covering material may have a touch sensitive surface (e.g., a capacitive touch sensitive surface). In addition, a sensor having a camera (e.g., the inside sensor 180 or on or proximate to the covering material) may be configured to detect a gesture on or near the covering material for changing the color and/or pattern of the covering material. The user may change the covering material color/pattern to match changing décor of the space.

As an example, the user may change the covering material (e.g., their colors, patterns, and/or other characteristic of the covering material) based on the season, holidays, occasions, and/or the like. During the summer, the user may prefer to have lighter color shades. The user may choose appropriate colors, patterns, and/or other characteristic of the covering material from the app on the mobile device and/or actuating the button (e.g., on the remote control and/or side of the fabric shades). When the control circuit of the motorized window treatment detects the user selection (e.g., via the first communication circuit 206), the motor drive unit control circuit 202 may control the motor drive circuit 210 and/or the covering material drive circuit 238 (e.g., via the covering material control circuit 232) to change the colors and/or the patterns of the fabric shades. In the fall, the user may adjust the color/pattern of the shades to a color/pattern that compliments the room décor and has a fall color tone. During the holiday seasons, such as Christmas, the user may change the shades to red and green patterns to coordinate with holiday accessories. For other moods or occasions, the user may adjust the shades appropriately (e.g., and may add a new excitement to the home and/or allow the user to keep their spaces interesting and fresh).

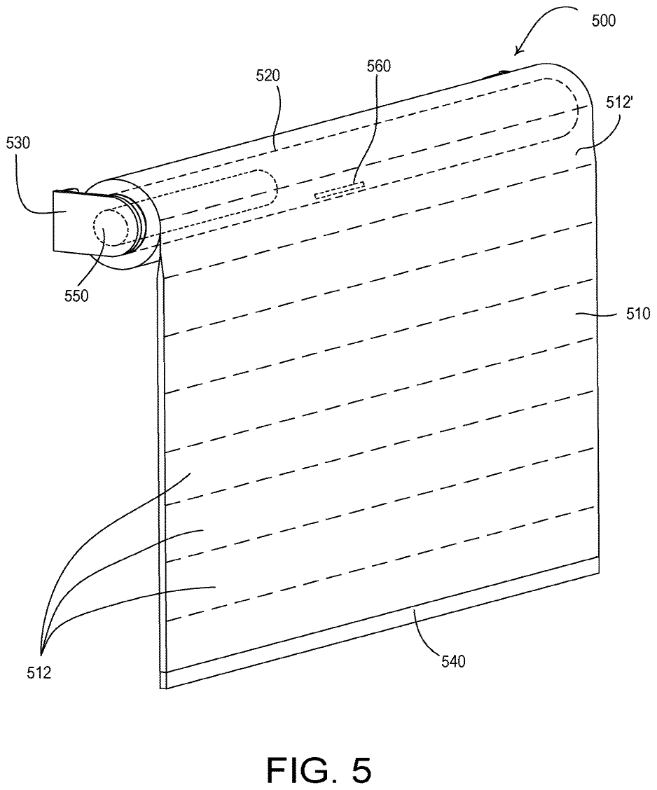

FIG. 5 is a perspective view of an example motorized window treatment 500 having a covering material, e.g., a covering material 510, characterized by a variable thickness. The covering material 510 may be configured to expand and/or contract, e.g., based on heat, electricity, and/or the like. For example, the covering material 510 may be a thermally-expandable fabric. The visible light transmittance of the covering material 510 may be adjusted by adjusting the thickness of the fabric. The covering material 510 may be windingly received around a roller tube 520. The roller tube 520 may be rotatably supported by mounting brackets 530, which may be attached to structure adjacent a window (e.g., a wall or ceiling) that may be covered by the covering material 510. A hembar 540 may be connected to a lower edge of the covering material 510 and may be configured to weigh down the covering material 510.

The motorized window treatment 500 may comprise a motor drive unit 550 (e.g., the motor drive unit 220 shown in FIG. 2A) that may be located inside of the roller tube 520. The motor drive unit 550 may include a motor (not shown) configured to rotate the roller tube 520 to cause the covering material 510 to be wound or unwound from the roller tube 520 to raise and lower the hembar 540. The motor drive unit 550 may be configured to adjust the covering material 510 between a lowered position (e.g., a fully-closed position) and a raised position (e.g., a fully-open position) and to retain the covering material 510 at any position between the lowered position and the raised position. The motorized window treatment 500 may also comprise a covering material control unit 560 (e.g., the flexible material control unit 230 shown in FIG. 2A), which may be mounted to and/or integrated into the roller tube 540 and may be configured to control one or more fabric characteristics of the covering material 510. The covering material control unit 560 may be configured to receive feedback indicating a visible light transmittance of the covering material 510. The covering material control unit 560 may be configured to increase or decrease the heat and/or electricity applied to the covering material 510 based on the feedback. The covering material control unit 560 may communicate wirelessly (e.g., via a short-range wireless communication link) with the motor drive unit 550.

The covering material 510 may have multiple thermally-expandable zones 512 (e.g., horizontal shade control zones). The zones 512 may be expanded using heat and/or an electric current. Each of the zones 512 may include one or more wires to conduct the heat and/or electric current within the respective zone. The covering material control unit 560 may conduct the heat and/or electric current to the wires of the zones to control. The covering material 510 may be responsive to the amount of heat and/or the amount of electric current to adjust the thickness of the covering material 510. For example, the covering material control unit 560 may be configured to control the thickness of each of the zones 512 of the covering material 510 that are hanging below the roller tube 520. For example, a top-most zone 512′ (e.g., that may be partially wrapped around the roller tube 520) may be controlled by the covering material control unit 560 to be thinner than the other zones 512 hanging below the roller tube 520. As the covering material 510 gets wrapped up around the roller tube 520, the size of the rolled-up covering material or the first zone 510 may get bigger, and the space may be limited, for example, in a pocket and/or installation cavity in which the roller tube 520 is located. By contracting the covering material 510 as the covering material 510 is rolled onto the roller tube 520, space may be saved (e.g., alternatively, or additionally, the mounting bracket may be smaller) and/or the user may use more covering material 510 (e.g., longer covering material). By expanding the covering material 510 as the covering material 510 is rolled down off of the roller tube, the visible light transmittance (e.g., openness factor) of the covering material 510 may be adjusted and the amount of light entering the space through the covering material 510 may be controlled. For example, the covering material 510 may include one or more holes and/or a surface texture. The holes and/or the surface texture may be configured to be altered as the thickness of the covering material 510 is adjusted such that the visible light transmittance of the covering material is adjusted.

The covering material 510 may be a flexible LCD. Each of the zones 512 of the flexible LCD may be LCD zones that can be made darker or lighter. When the covering material 510 is a flexible LCD, the flexible material control unit 560 may control the zones that are wrapped around the roller tube 520. In this case, the flexible material control unit 560 may not have to determine how much of the flexible material 510 is unwrapped from the roller tube 520.

A motorized window treatment may determine a position of a covering material of the motorized window treatment. The position may include a location of the hembar. Determining the position of the covering material may include determining an amount of covering material that is wrapped around the roller tube of the motorized window treatment. When the covering material includes a plurality of zones along a length of the covering material, the motorized window treatment may determine which of the plurality of zones are unwrapped from the roller tube. The motorized window treatment may be configured to control the zones that are unwrapped from the roller tube. The motorized window treatment may be configured to control a visible light transmittance of one or more of the zones that are unwrapped from the roller tube, for example, by adjusting a thickness of the covering material in the zones that are unwrapped.

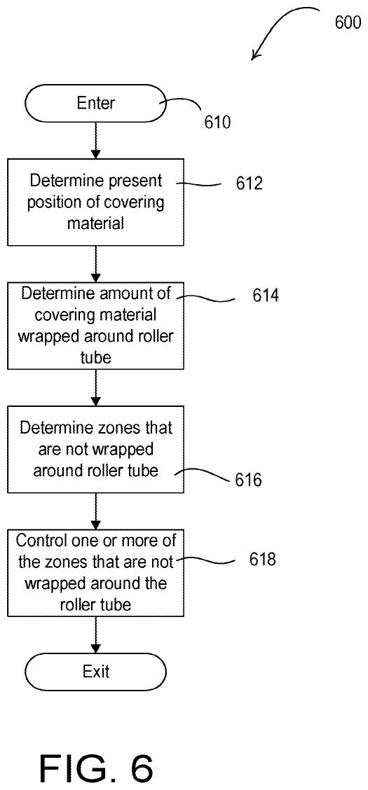

FIG. 6 is a flowchart of an example process 600 of controlling a motorized window treatment with a variable-thickness covering material (e.g., the motorized window treatment 500 shown in FIG. 5). The process 600 may be performed at a single device or distributed across multiple devices. For example, the process 600 may be performed at a control circuit of a load control device (e.g., the motor drive unit control circuit 202 of the motor drive unit 220 of the motorized window treatment 200 and/or the flexible material control circuit 232 of the flexible material control unit 230). Though the process 600 may be described with reference to a certain device, such as the motorized window treatment 500, one or more other devices in a load control system (e.g., the load control system 100) may be implemented to perform similar functionality. For example, information may be provided to a system controller or another control device for making determinations on performing control of the motorized window treatment and control instructions for performing such control may be communicated to the motorized window treatment.

As shown in FIG. 6, the process 600 may begin at 610. At 612, the motorized window treatment may determine a present position of the covering material (e.g., the present position of the hembar 540 of the covering material 510) of the motorized window treatment. The control circuit may determine the current position of the covering material based on retrieving the information from a memory (e.g., the memory 204) and or in response to a rotational sensing circuit (e.g., the rotational sensing circuit 214), for example.

At 614, the control circuit of the motorized window treatment may determine a length L_{WRAP} of covering material wrapped around the roller tube. For example, the control circuit may be configured to count the number N_{REV} of revolutions (e.g., full or partial revolutions) of the roller tube and calculate the length L_{WRAP} of covering material wrapped around the roller tube using a known length L_{REV} of covering material wrapped around the roller tube for a single revolution, e.g., L_{WRAP}=N_{REV}−L_{REV}. An example of a motorized window treatment that is configured to keep track of how much fabric is wrapped around a roller tube is described in greater detail in U.S. Pat. No. 7,281,565, issued Oct. 16, 2007, entitled SYSTEM FOR CONTROLLING ROLLER TUBE ROTATIONAL SPEED FOR CONSTANT LINEAR SHADE SPEED, the entire disclosure of which is hereby incorporated by reference.

At 616, the control circuit of the motorized window treatment may determine shade control zones (e.g., zones 512) that are in the unwrapped portion of the covering material. For example, the control circuit may be configured to determine a length L_{UNWRAP} of unwrapped covering material using a known total length L_{TOT} of the covering material and the length L_{WRAP} of the wrapped covering material (e.g., as determined at 614), e.g., L_{UNWRAP}=L_{TOT}−L_{WRAP}. The control circuit may be configured to determine a number N_{ZONE} of the shade control zones that are in the unwrapped portion of the fabric using a known length L_{ZONE} of each zone and the length L_{UNWRAP} of unwrapped covering material, e.g., N_{ZONE}=L_{TOT}/L_{ZONE}. If the shade control zones are numbered sequentially starting from one at the bottom of the covering material, the control circuit may be configured to determine that the shade control zones that are in the unwrapped covering material are those zones that are numbered from one to the number N_{ZONE}.

At 618, the motorized window treatment may control the thickness of one or more of the shade control zones in the unwrapped portion of the covering material (e.g., one or more of the zones that are numbered from one to the number N_{ZONE} as determined at 616). As described herein, the control may control the thickness of the fabric that is unwrapped around the roller tube and may adjust the amount of light entering the space through the covering material (e.g., change the visible light transmittance of the covering material). In addition, the thickness of the covering material may be adjusted for aesthetic reasons. For example, a customer may desire an aesthetically-pleasing, but thick covering material. The covering material may be controlled to be thinner as the covering material is wrapped around the roller tube, such that the wrapped covering material may take up less space and may be more easily concealed. In examples, one or more first zones in the unwrapped portion of the covering material may be controlled to a first thickness (e.g., to achieve a first visible light transmittance) and one or more second zones in the unwrapped portion of the covering material may be controlled to a second thickness (e.g., to achieve a second visible light transmittance). For example, the first zone(s) may be an upper zone(s) and the second zone(s) may be a lower zone(s). The first zone(s) may be controlled to a lower visible light transmittance (e.g., opaque or near-opaque), for example, to block out direct sun glare. The second zone(s) may be controlled to a higher visible light transmittance (e.g., transparent, translucent, or semi-transparent), for example, to block out indirect sun glare. The flexible material control unit may determine which zone(s) is/are the first zone(s) and which zone(s) is/are the second zone(s).

FIG. 7 is a perspective view of an example motorized window treatment system 700 comprising a motorized window treatment 702 (e.g., such as the motorized window treatment 150 shown in FIG. 1A and/or the motorized window treatment 150a, 150b shown in FIG. 1B) having a stretchable covering material 704. The covering material 704 may be windingly received around a roller tube 706. The roller tube 706 may be rotatably supported by mounting brackets 708, which may be attached to a structure adjacent a window (e.g., a wall or ceiling) that may be covered by the covering material 704. A hembar 710 may engage (e.g., be connected to) a lower end (e.g., edge) of the covering material 704 and may be configured to weigh down the covering material 704. The motorized window treatment 702 may comprise a motor drive unit 720 that may be located inside of the roller tube 706. The motor drive unit 720 may include a motor (not shown) configured to rotate the roller tube 706 to cause the covering material 704 to be wound or unwound from the roller tube 706 to raise and lower the hembar 710. The motor drive unit 720 may be configured to adjust the covering material 704 between a lowered position (e.g., a fully-closed position) and a raised position (e.g., a fully-open position) and to retain the covering material 704 at any position between to the lowered position and the raised position. For example, the motorized window treatment system 700 may be configured to move the hembar 710 between the lowered position and the raised position. The hembar 710 may be moved to a certain position based on a privacy setting and/or a position of the sun.

The motorized window treatment system 700 may comprise one or more cables 730 that may extend parallel to the covering material 704 adjacent to opposing sides 705 of the covering material 704. The cables 730 may each extend between mounting structures 732 that may be adapted to mount the cables to the structure surrounding the window, such as a window sill, a ceiling, or other structure. For example, the mounting structures 732 may be configured to be attached to the structure surrounding the window. An example of description of a cabled-guided motorized window treatment having cables held in place by mounting structures, such as the mounting structures 732, is described in greater detail in U.S. Pat. No. 9,382,756, issued Jul. 5, 2016, entitled CABLE GUIDED SHADE SYSTEM, the entire disclosure of which is hereby incorporated by reference.

The cables 730 may extend through the hembar 710. For example, each of the cables 730 may extend through respective openings 712 at opposing ends 714 of the hembar 710. The cables 730 may be configured to enable the hembar 710 to be locked in a locked position. The locked position may be any position between the lowered position and the raised position. For example, the hembar 710 may be locked in any position between the lowered position and the raised position. The hembar 710 may include respective clamping mechanisms 740 (e.g., clamps) for each of the cables 730. The clamping mechanisms 740 may be configured to clamp the respective cables 730 to lock the hembar 710 in the locked position. The clamping mechanisms 740 may be located at the opposing ends 714 of the hembar 710 for clamping to the sections of the respective cables 720 that are in the respective openings 712 for locking the hembar in place with respect to the cables 730.

The hembar 710 may comprise a hembar control unit 750 (e.g., such as the hembar control unit 250 shown in FIG. 2B) that may be configured to control (e.g., simultaneously control) the clamping mechanisms 740 to lock and unlock the hembar 710 in place with respect to the cables 730. For example, the hembar control unit 750 may be configured to control the clamping mechanisms 740 based on control instructions received from the motor drive unit or another external control device. The control instructions may indicate a target locked position of the hembar 710. The hembar control unit 750 may be configured to determine a position of the hembar 710. The hembar control unit 750 may be configured to operate the clamping mechanisms 740 to lock the hembar 710 when the hembar 710 reaches the target locked position. The hembar control unit 750 may be configured to control the clamping mechanisms 740 in response to wireless signals (e.g., RF signals) received from the motor drive unit 720. For example, the control instructions may be received via the wireless signals from the motor drive unit 720. The hembar control unit 750 and/or the clamping mechanisms 740 may be battery-powered. For example, the hembar control unit 750 may include a battery for powering the hembar control unit 750 and/or the clamping mechanisms 740. The hembar control unit 750 and/or the clamping mechanisms may be powered by an internal power supply (e.g., such as the internal power supply 260 shown in FIG. 2B) that is fed from a power supply in the motor drive unit 720 via power lines that run through or proximate to the covering material 704. Additionally or alternatively, the motorized window treatment 702 (e.g., the hembar 710) may include a solar cell for powering the hembar control unit 750 and/or the clamping mechanisms 740.

A visible light transmittance of a covering material of a motorized window treatment may be adjusted, for example, when the covering material is in a fixed position (e.g., a locked position). The covering material may be in the fixed position when a hembar attached to the covering material is locked to prevent vertical movement. A roller tube of the motorized window treatment may be rotated when the covering material (e.g., the hembar) is in the fixed position. For example, the roller tube may be rotated in the raising direction when the hembar is in the fixed position to stretch the covering material. The visible light transmittance and/or a position of the hembar may be adjusted based on a desired amount of light to allow into a room through a window proximate to the motorized window treatment. For example, the position of the hembar may be adjusted by rotating a roller tube of the motorized window treatment until the hembar is in a desired position (e.g., a locked position). The desired position may be determined based on the desired amount of light to allow into a room through the window, a position of the sun, and/or a privacy setting.

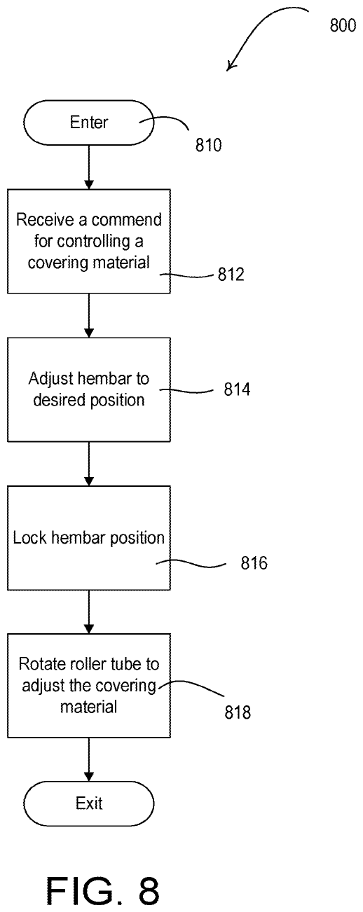

FIG. 8 is a flowchart of an example process 800 for controlling a motorized window treatment with a stretchable covering material (e.g., the motorized window treatment 700 shown in FIG. 7). The process 800 may be performed at a single device or distributed across multiple devices. For example, the process 800 may be performed at a control circuit of a load control device (e.g., the motor drive unit control circuit 202 of the motor drive unit 220 of the motorized window treatment 200). Though the process 800 may be described with reference to a certain device, such as the motorized window treatment 700, one or more other devices in a load control system (e.g., the load control system 100) may be implemented to perform similar functionality. For example, information may be provided to a system controller or another control device for making determinations on performing control of the motorized window treatment and control instructions for performing such control may be communicated to the motorized window treatment.

As shown in FIG. 8, the process 800 may begin at 810. At 812, the control circuit of the motorized window treatment may receive a command for controlling the covering material. For example, the command may include a desired position for a hembar (e.g., the hembar 710) and/or a desired visible light transmittance (e.g., openness factor) for the covering material. The motorized window treatment may receive the command when the hembar is in a first locked position and/or when the covering material is stretched. When the command is received while the covering material is stretched, the roller tube may be rotated to unstretch the covering material before unlocking the hembar. The command may indicate a privacy setting and/or a desired amount of light to allow into the room through a window proximate to the motorized window treatment. For example, the command may indicate a desired amount of direct sunlight penetration into the space. The command may indicate a total amount of light in the space. The total amount of light in the space may include light from lights in the space, sunlight shining through the covering material, and light shining through the window where the covering material is not covering.

At 814, the control circuit may control a motor to rotate a roller tube (e.g., the roller tube 706) to adjust the hembar to the desired position (e.g., as received at 812). For example, the motorized window treatment 200 may lower the covering material down to the window sill (e.g., to a lowered position) or lower the covering material down to the middle of the window frame (e.g., to an intermediate position between the lowered position and a raised position).

At 816, the motorized window treatment may lock the hembar at the desired position (e.g., a locked position). For example, the control circuit of the motor drive unit may transmit (e.g., wirelessly transmit) a message to a hembar control unit (e.g., the hembar control unit 750) in the hembar to cause clamping mechanisms (e.g., the clamping mechanisms 740). The hembar control unit may transmit a message back to the motor drive unit to indicate that the hembar is locked at the desired position. Additionally or alternatively, the hembar may be configured to engage a lock on the window sill. The hembar control unit may be configured to disengage the lock. When the hembar is locked at the window sill, the covering material may be stretched (e.g., by rotating the roller tube) to adjust the visible light transmittance of the covering material.

At 818, the control circuit of the motor drive unit may control the motor to rotate the roller tube to adjust the visible light transmittance (e.g., openness factor) of the covering material to the desired visible light transmittance. For example, the control circuit may rotate the roller tube (e.g., in the same direction as to raise the covering material) to tighten (e.g., stretch) the covering material while the hembar is in the desired position. For example, the covering material may have a visible light transmittance (e.g., an openness factor) of zero percent (e.g., the covering material is opaque or in a blackout state) when the covering material is not stretched, and the visible light transmittance of the covering material may increase as the covering material is tightened. The control circuit may determine an amount to rotate the roller tube to achieve the desired visible light transmittance. For example, the control circuit may retrieve an amount to rotate the roller tube from memory (e.g., the memory 254 shown in FIG. 2B) based on the desired openness factor. In addition, the covering material may have an openness factor greater than zero when the covering material is not stretched, and the visible light transmittance of the covering material may decrease as the covering material is tightened until the covering material has an openness factor of zero percent.

FIG. 9 is a perspective view and FIG. 10 is a side view of an example motorized window treatment 900 having a soft-sheer covering material 910 with adjustable vanes 920. As shown in FIG. 10, the vanes 920 each comprises a plurality of fixed vanes 922 and a plurality of adjustable vanes 924 that may be adjusted (e.g., lowered) to provide different levels of visible light transmittance for the covering material 910. The covering material 910 may also comprise first and second panels 912, 914 (e.g., outer sheer shade panels) between which the fixed vanes 922 extend. For example, the vanes 920 extend between the first and second panels 912, 914. The motorized window treatment 900 may comprise a headrail 930 for housing a roller tube 932 around which the covering material 910 may be wrapped. The headrail 930 of the motorized window treatment 900 may also comprise a motor drive unit (e.g., such as the motor drive unit 270 shown in FIG. 2C) for rotating the roller tube 932 to adjust the covering material 910 (e.g., raise and lower the covering material). The motor drive unit may be located within the roller tube. The motor drive unit may include a motor drive shaft that defines a motor drive shaft rotational axis in a longitudinal direction. The motor drive shaft may be configured to rotate the roller tube to adjust the covering material 910 between a raised position and a lowered position. An example of a motorized window treatment having a soft-sheer fabric (e.g., with fixed vanes) is described in greater detail in commonly-assigned U.S. Pat. No. 9,611,689, issued Apr. 4, 2017, entitled MOTORIZED SHEER SHADING SYSTEM, the entire disclosure of which is hereby incorporated by reference.

The visible light transmittance of a venetian blind system may be adjusted. For example, the slats of the venetian blind system may have differing visible light transmittance. The slats may include one or more rigid slats and one or more fabric vanes. The visible light transmittance of the one or more fabric vanes may be adjusted. The one or more rigid slats may have differing transparency and/or translucency. For example, the fabric vanes may be controlled (e.g., tilted) to adjust the visible light transmittance of the venetian blind system. An example of a motorized window treatment having a venetian blinds is described in greater detail in commonly-assigned U.S. Pat. No. 8,723,466, issued May 13, 2014, entitled MOTORIZED VENETIAN BLIND SYSTEM, the entire disclosure of which is hereby incorporated by reference.

The adjustable vanes 924 may be tilted (e.g., lowered or raised) by a tilt cord 940 that may be connected to one end of each of the adjustable vanes 924. The motorized window treatment 900 may be configured to raise and lower the tilt cord 940 to tilt the adjustable vanes 924 between an open position and a closed position. For example, the headrail 930 of the motorized window treatment 900 may comprise a mechanism 950 for raising and lowering the tilt cord 940 to raise and lower the adjustable vanes 924. The mechanism 950 may include a spool for winding receiving the tilt cord 940. The mechanism 950 may include a motor (e.g., such as the motor 212B) for rotating the spool. Each of the adjustable vanes 924 define a first end 926 that is attached to the first panel 912 and a second end 928 that is attached to the tilt cord 940. The visible light transmittance of the covering material 910 may be increased as the tilt cord 940 is raised. The visible light transmittance of the covering material 910 may be decreased as the tilt cord 940 is lowered. The second end 938 is proximate to the adjacent one of the fixed vanes 922 when the adjustable vanes 924 are in the open position. The second end 938 may be distal from the adjacent one of the fixed vanes 922 when the adjustable vanes are in the closed position. The adjustable vanes 924 may be lowered until the adjustable vanes 924 contact (e.g., rest against) the first outer sheer shade panel 912.

The fixed vanes 922 and the adjustable vanes 924 may be flexible, for example, to enable winding about the roller tube 932. The surfaces of the adjustable vanes 924 that are lowered may have different fabric characteristics. For example, when the adjustable vanes 924 are lowered, the covering material 910 may reduce the visible light transmittance of the covering material 910 (e.g., an opaque state). When the adjustable vanes 924 are raised (e.g., adjacent to the fixed vanes 922), the covering material 910 may increase the visible light transmittance of the covering material 910 (e.g., a transparent state). The vanes 920 may be configured to change color (e.g., a color of the covering material 910). For example, each of the adjustable vanes 924 may define a color. As the adjustable vanes 924 are raised and/or lowered, the color of the covering material 910 may be changed.

The vanes 920 may include one or more light sources (e.g., such as the light sources 1114 shown in FIG. 11). The motorized window treatment 900 may comprise a lighting control drive circuit (e.g., such as the lighting control drive circuit 246 shown in FIG. 2D) that controls the light sources to adjust an intensity and/or color of light emitted. The light sources may be controlled to emit light into the space and/or emit light out the window. The light sources may be controlled to change the appearance of the covering material 910. For example, the light sources may be controlled to display an image on the covering material 910.

In addition, each vane 920 may have multiple sets of adjustable vanes that may be lowered (e.g., with respective tilt cords) to provide different levels of visible light transmittance. For example, the adjustable vanes 924 may include a first set of adjustable vanes and a second set of adjustable vanes. The visible light transmittance of the covering material 910 may be adjusted by controlling the first set of adjustable vanes and the second set of adjustable vanes. The first set of adjustable vanes may be capable of tilting independently from the second set of adjustable vanes. For example, the tilt cord 940 may include a first tilt cord capable of being operated such that the first set of adjustable vanes can be tilted and a second tilt cord capable of being operated such that the second set of adjustable vanes can be tilted. For example, the first set of adjustable vanes may be tilted to a different position than the second set of adjustable vanes. The first set of adjustable vanes may have a different transparency than the second set of adjustable vanes. For example, the first set of adjustable vanes may define a first visible light transmittance and the second set of adjustable vanes may define a second visible light transmittance.

Alternatively, or additionally, the vanes 920 may each have adjustable vanes that may be raised (e.g., rather than lowered as shown in FIG. 10). For example, the tilt cord 940 may be located proximate to the first panel 912 such that the first end 926 of the adjustable vanes 924 is attached thereto. An example of a motorized window treatment having a mechanism for raising and lowering a cord is described below with reference to FIG. 11.

FIG. 11 is a perspective view of an example motorized window treatment 1000 having a cellular covering material 1110 (e.g., a honeycomb covering material). For example, the covering material 1110 may include a plurality of cell structures that are aligned vertically. Each of the cell structures of the covering material 1110 may define a hexagonal prism. Each of the cell structures may be collapsible as the covering material 1110 is operated between the raised position and the lowered position. The motorized window treatment 1100 may comprise a headrail 1120 from which the covering material 1110 hangs and a bottom bar 1122 at a lower edge of the covering material 1110. The motorized window treatment 1100 may comprise lift cords 1124 that extend between the headrail 1120 and the bottom bar 1122. The motorized window treatment 1100 may comprise a motor drive unit 1130 and cord spools 1132 located in the headrail 1120. The motor drive unit 1130 may be configured to rotate to adjust the covering material 1110 between a raised position and a lowered position. Each of the cell structures may be collapsible as the covering material 1110 is operated between the raised position and the lowered position. The cord spools 1132 may be operably coupled to the motor drive unit 1130 (e.g., the motor drive shaft). The lift cords 1124 may be attached to respective cord spools 1132. The motor drive unit 1130 may be configured to rotate the cord spools 1132 to wrap and unwrap the respective lift cords 1124 around the cord spools to raise and lower the bottom bar 1122 and thus raise and lower the covering material 1110. For example, rotation of the cord spools 1132 enables the lift cords 1124 to raise and lower the covering material 1110 between the raised position and the lowered position. An example of a motorized window treatment having a mechanism for raising and lowering one or more lift cords is described below in commonly assigned U.S. Pat. No. 8,950,461, issued Feb. 10, 2015, entitled MOTORIZED WINDOW TREATMENT, the entire disclosure of which is hereby incorporated by reference.

The covering material 1110 may a light-emitting fabric having light sources, such as LEDs 1114, inside of the covering material. The covering material may comprise openings 1112 that extend along the width of the covering material. The openings 1112 may be defined by the cell structures of the covering material 1110. The covering material 1110 may further comprise a plurality of light sources, such as the LEDs 1114 located in the covering material 1110 (e.g., the cell structures). For example, the LEDs 1114 may be located inside of the openings 1112 of the covering material 1110. For example, the LEDs 1114 may be arranged in each of the openings 1112 of the covering material 1110 in linear array across the width of the covering material. While only three openings 1112 of the covering material 1110 are shown in FIG. 11 including the LEDs 1114, all of the openings 1112 of the covering material 1110 may include the LEDs 1114 or alternating openings 1112 of the covering material 1110 (e.g., every other opening) could include the LEDs 1114. The LEDs 1114 may be electrically connected to the motor drive unit 1130 and/or another control unit (not shown) located in the headrail 1120, such as an LED driver. For example, the LEDs 1114 may be electrically connected to the motor drive unit or other control unit via electrical wiring (not shown) extending adjacent to the lift cords and/or the lift cords may be electrically conductive.

As described herein, the control circuit of the motor drive unit 1130 and/or other control unit in the headrail 1120 may be configured to adjust the intensities of the LEDs 1114 in the covering material 1110, for example, to provide lighting in a space in which the motorized window treatment is controlled. For example, the control circuit of the motor drive unit 1130 or the control unit in the headrail 1120 may be coupled to the covering material 1110 to adjust the color of the covering material 1110 using the LEDs 1114. The control circuit of the motor drive unit 1130 or the control unit in the headrail 1120 may separately control each of the LEDs 1114. Alternatively, the control circuit of the motor drive unit 1130 or the control unit in the headrail 1120 may control each of the LEDs 1114 in a respective one of the openings 1112 (e.g., in one of the cell structures of the flexible material 1110) separately such that a light intensity and/or a color of each cell structure can be controlled independently. The control circuit of the motor drive unit 1130 or the control unit in the head rail 1120 may be configured to determine a length of the covering material 1110 that is extended from the headrail 1120. For example, the control circuit of the motor drive unit 1130 or the control unit in the headrail 1120 may be configured to determine a distance between the bottom bar 1122 and the headrail 1120. The control circuit of the motor drive unit 1130 or the control unit in the headrail 1120 may be configured to control the intensity and/or color of the LEDs 1114 (e.g., only the LEDs 1114) in the length of the covering material 1110 that is extended from the headrail 1120. The control circuit of the motor drive unit 1130 or the control unit in the headrail 1120 may be configured to control the LEDs 1114 in response to detection of a gesture, for example, that is proximate to the motorized window treatment 1100.

The LEDs 1114 may be configured to illuminate a non-window side of the covering material 1110. In addition, the LEDs 1114 may comprise LEDs of multiple colors and may be controlled to adjust a color of the covering material 1110. The LEDs 1114 may also be controlled to simulate as natural light (e.g., imitating sunrise and/or sunset through scheduled events) and/or provide additional electric light (e.g., alternatively, or additionally, to lamps, downlights, etc., installed in the space). Further, the LEDs 1114 may be controlled to provide lighting on an outside surface of the covering material 1110 (e.g., for enhanced security as described herein). For example, the LEDs 1114 may be configured to illuminate a window side of the covering material 1110. An example of a system for shining light on an outside surface of a covering material is described in greater detail in commonly-assigned U.S. Pat. No. 9,169,690, issued Oct. 27, 2015, entitled WINDOW TREATMENT HAVING BACKLIGHT, the entire disclosure of which is hereby incorporated by reference.

As described herein, the colors and/or the patterns on covering material of a motorized window treatment may be changed using nanotechnology. For example, the user may use a device (e.g., a camera) to determine the color and/or the pattern of the shade. Based on the determination, the covering material drive circuit may change the color and/or the pattern of covering material to match the determined color/pattern.

FIGS. 12A and 12B are front views of a portion of an example covering material 1200 (e.g., a covering material) characterized by a variable visible light transmittance that is configured to be used in a motorized window treatment (e.g., such as the motorized window treatment 150 shown in FIG. 1A, the motorized window treatment 150a shown in FIG. 1B, the motorized window treatment 500 shown in FIG. 5, and/or the motorized window treatment 700 shown in FIG. 7). The covering material may be configured to be attached to the roller tube of the motorized window treatment. The motor drive unit of the motorized window treatment may be configured to rotate the roller tube to adjust the covering material 1200 between a raised position and a lowered position. The motorized window treatment may be configured to adjust a color or a pattern of the covering material 1200.

The covering material 1200 may comprise two parallel fabric panels. Each of the fabric panels of the covering material 1200 may comprise a crisscross mesh weave of fabric strands. For example, the first panel may define a firs mesh weave having a first pattern. The first pattern may include a plurality of fabric strands that define a first plurality of vertices. The second panel may define a second mesh weave having a second pattern. The second pattern may include a plurality of fabric strands that define a second plurality of vertices. The first patter and the second pattern may be the same. Alternatively, the first pattern may be different than the second pattern.

When adjusting the visible light transmittance (e.g., openness factor) of the covering material 1200, the first fabric panel may be held in a fixed position and the position of the second fabric panel may be adjusted. For example, the first fabric panel may remain stationary as the second panel is configured to be translated between a first position and a second position. The first fabric panel may be on a non-window side of the motorized window treatment. The second fabric panel may be on a window side of the motorized window treatment. As shown in FIG. 12A, the second fabric panel may be in the first position when the fabric strands of the second fabric panel are aligned or nearly aligned with the fabric strands of the first fabric panel. As shown in FIG. 12B, the second fabric panel may be in the second position when the fabric stands of the second fabric panel are not aligned with the fabric strands of the first fabric panel. For example, the fabric strands of the second fabric panel may be equally spaced apart from the fabric strands of the first fabric panel in the second position. Stated differently, the second plurality of vertices may be located at a midpoint between the first plurality of vertices when the second fabric panel is in the second position. The second fabric panel may be moved in equal distances in the X-direction and Y-direction to move the second fabric panel from the first position to the second position and vice versa. For example, the second fabric panel may be shifted in the Y-direction as the second fabric panel is raised (e.g., in the X-direction) while the first fabric panel is stationary.

When the second fabric panel is in the second position, the covering material 1200 may have a different visible light transmittance (e.g., openness factor) than when the second fabric panel is in the first position. For example, the openness factor of covering material 1200 may be greater when the second fabric panel is in the first position than when the second fabric panel is in the first position. Stated differently, the visible light transmittance of the covering material 1200 may be greater when the second fabric panel is in the second position. The visible light transmittance of the covering material 1200 may be at a maximum when the second fabric panel is in the first position. The visible light transmittance of the covering material 1200 may be at a minimum when the second fabric panel is in the second position. The thickness of the fabric strands and the distance between the fabric strands of the first and second fabric panels may be sized differently to change the openness factors when the second fabric panel is in the first and second positions. For example, the thickness of the fabric strands and the distance between the fabric strands of the first and second fabric panels may be sized such that the openness factor of the covering material 1200 is approximately zero percent when the second fabric panel is in the second position. Additionally or alternatively, the second fabric panel of the covering material 1200 may be configured to be stretched.

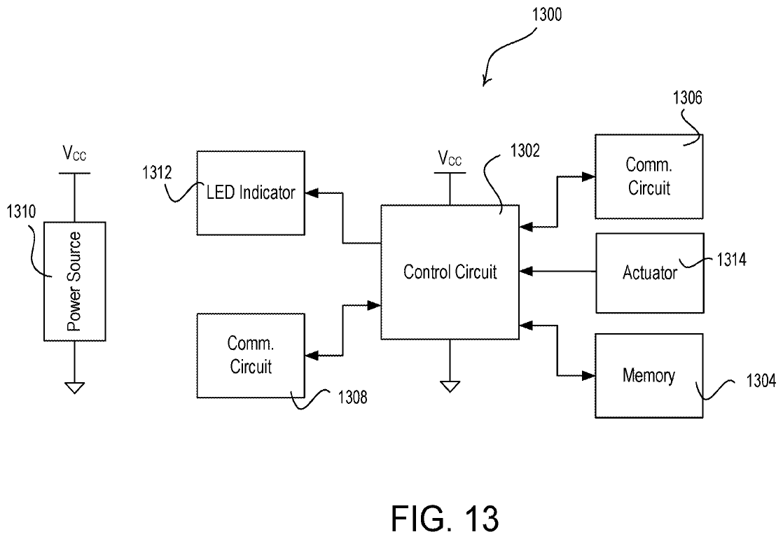

FIG. 13 is a block diagram illustrating an example system controller 1300 (such as system controller 110, described herein). The system controller 1300 may include a control circuit 1302 for controlling the functionality of the system controller 1300. The control circuit 1302 may include one or more general purpose processors, special purpose processors, conventional processors, digital signal processors (DSPs), microprocessors, integrated circuits, a programmable logic device (PLD), application specific integrated circuits (ASICs), or the like. The control circuit 1302 may perform signal coding, data processing, image processing, power control, input/output processing, color temperature processing, or any other functionality that enables the system controller 1300 to perform as described herein.

The control circuit 1302 may store information in and/or retrieve information from the memory 1304. The memory 1304 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory.

The system controller 1300 may include a communications circuit 1306 for transmitting and/or receiving information. The communications circuit 1306 may perform wireless and/or wired communications. The system controller 1300 may also, or alternatively, include a communications circuit 1308 for transmitting and/or receiving information. The communications circuit 1308 may perform wireless and/or wired communications. Communications circuits 1306 and 1308 may be in communication with control circuit 1302. The communications circuits 1306 and 1308 may include RF transceivers or other communications circuits capable of performing wireless communications via an antenna. The communications circuit 1306 and communications circuit 1308 may be capable of performing communications via the same communication channels or different communication channels. For example, the communications circuit 1306 may be capable of communicating (e.g., with a network device, over a network, etc.) via a wireless communication channel (e.g., BLUETOOTH®, near field communication (NFC), WIFI®, WI-MAX®, cellular, etc.) and the communications circuit 1308 may be capable of communicating (e.g., with control devices and/or other devices in the load control system) via another wireless communication channel (e.g., WI-FI®, Zigbee®, Thread® or a proprietary communication channel, such as Clear Connect®).

The control circuit 1302 may be in communication with an LED indicator 1312 for providing indications to a user. The control circuit 1302 may be in communication with an actuator 1314 (e.g., one or more buttons) that may be actuated by a user to communicate user selections to the control circuit 1302. For example, the actuator 1314 may be actuated to put the control circuit 1302 in an association mode and/or communicate association messages from the system controller 1300.

Each of the circuits within the system controller 1300 may be powered by a power source 1310. The power source 1310 may include an AC power supply or DC power supply, for example. The power source 1310 may generate a supply voltage VCC for powering the circuits within the system controller 1300.

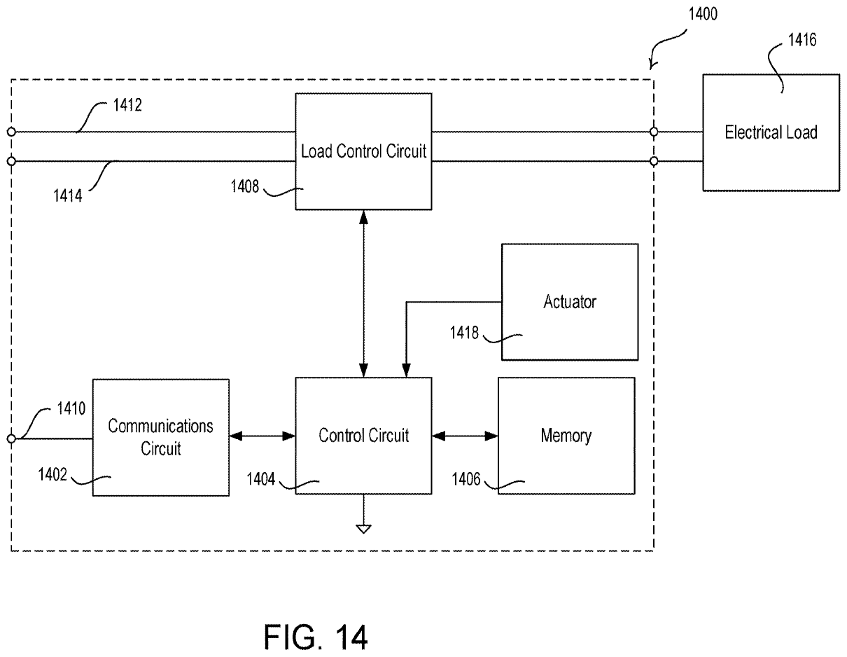

FIG. 14 is a block diagram illustrating an example control-target device, e.g., a load control device 1400, as described herein. The load control device 1400 may be a dimmer switch, an electronic switch, an electronic ballast for lamps, an LED driver for LED light sources, an AC plug-in load control device, a temperature control device (e.g., a thermostat), a motor drive unit for a motorized window treatment, or other load control device. The load control device 1400 may include a communications circuit 1402. The communications circuit 1402 may include a receiver, an RF transceiver, or other communications circuit capable of performing wired and/or wireless communications via communications link 1410. For example, the communications circuit 1402 may be capable of communicating (e.g., with a network device, over a network, etc.) via a wireless communication channel (e.g., BLUETOOTH®, near field communication (NFC), WIFI®, WI-MAX®, cellular, WI-FI®, Zigbee®, Thread® or a proprietary communication channel, such as Clear Connect®).

The communications circuit 1402 may be in communication with control circuit 1404. The control circuit 1404 may include one or more general purpose processors, special purpose processors, conventional processors, digital signal processors (DSPs), microprocessors, integrated circuits, a programmable logic device (PLD), application specific integrated circuits (ASICs), or the like. The control circuit 1404 may perform signal coding, data processing, power control, input/output processing, image processing, color temperature processing, or any other functionality that enables the load control device 1400 to perform as described herein.

The control circuit 1404 may store information in and/or retrieve information from the memory 1406. For example, the memory 1406 may maintain a registry of associated control devices and/or control instructions. The memory 1406 may include a non-removable memory and/or a removable memory.

The load control circuit 1408 may receive instructions from the control circuit 1404 and may control the electrical load 1416 based on the received instructions. For example, the electrical load 1416 may control an electric motor for controlling a motorized window treatment (e.g., motorized window treatment 150) or a lighting load (e.g., LED, fluorescent bulb, etc.). The load control device 1400 may include multiple load control circuits and/or multiple electrical loads for controlling multiple loads, such as multiple LEDs with multiple LED drivers. The load control circuit 1408 may send status feedback to the control circuit 1404 regarding the status of the electrical load 1416. The load control circuit 1408 may receive power via the hot connection 1412 and the neutral connection 1414 and may provide an amount of power to the electrical load 1416. The electrical load 1416 may include any type of electrical load.

The control circuit 1404 may be in communication with an actuator 1418 (e.g., one or more buttons) that may be actuated by a user to communicate user selections to the control circuit 1404. For example, the actuator 1418 may be actuated to put the control circuit 1404 in an association mode and/or communicate association messages from the load control device 1400.

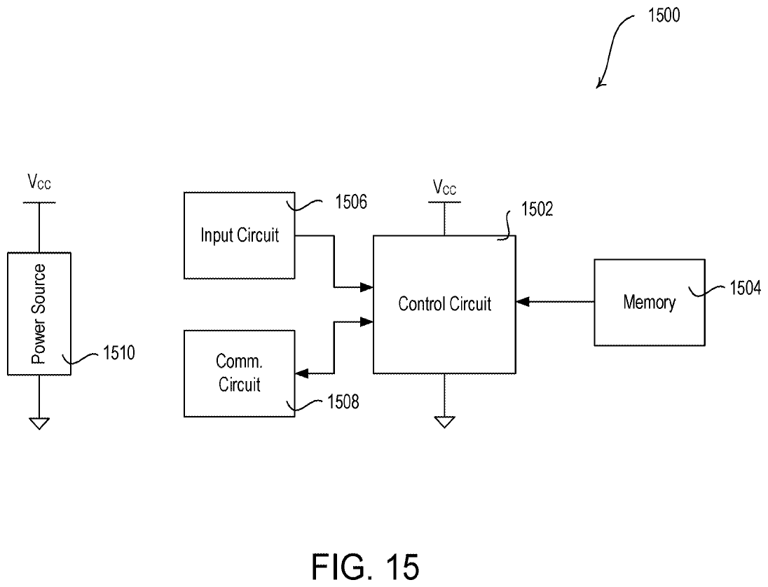

FIG. 15 is a block diagram illustrating an example control-source device 1500 as described herein. The control-source device 1500 may be a remote control device, an occupancy sensor, an outside light sensor, a temperature sensor, and/or the like. The control-source device 1500 may include a control circuit 1502 for controlling the functionality of the control-source device 1500. The control circuit 1502 may include one or more general purpose processors, special purpose processors, conventional processors, digital signal processors (DSPs), microprocessors, integrated circuits, a programmable logic device (PLD), application specific integrated circuits (ASICs), or the like. The control circuit 1502 may perform signal coding, data processing, power control, input/output processing, or any other functionality that enables the control-source device 1500 to perform as described herein.

The control circuit 1502 may store information in and/or retrieve information from the memory 1504. The memory 1504 may include a non-removable memory and/or a removable memory, as described herein.

The control-source device 1500 may include a communications circuit 1508 for transmitting and/or receiving information. The communications circuit 1508 may transmit and/or receive information via wired and/or wireless communications. The communications circuit 1508 may include a transmitter, an RF transceiver, or other circuit capable of performing wired and/or wireless communications. The communications circuit 1508 may be in communication with control circuit 1502 for transmitting and/or receiving information.

The control circuit 1502 may also be in communication with an input circuit 1506. The input circuit 1506 may include an actuator (e.g., one or more buttons) or a sensor circuit (e.g., an occupancy sensor circuit, an outside light sensor circuit, or a temperature sensor circuit) for receiving input that may be sent to a device for controlling an electrical load. For example, the control-source device may receive input from the input circuit 1506 to put the control circuit 1502 in an association mode and/or communicate association messages from the control-source device. The control circuit 1502 may receive information from the input circuit 1506 (e.g., an indication that a button has been actuated or sensed information). Each of the circuits within the control-source device 1500 may be powered by a power source 1510.

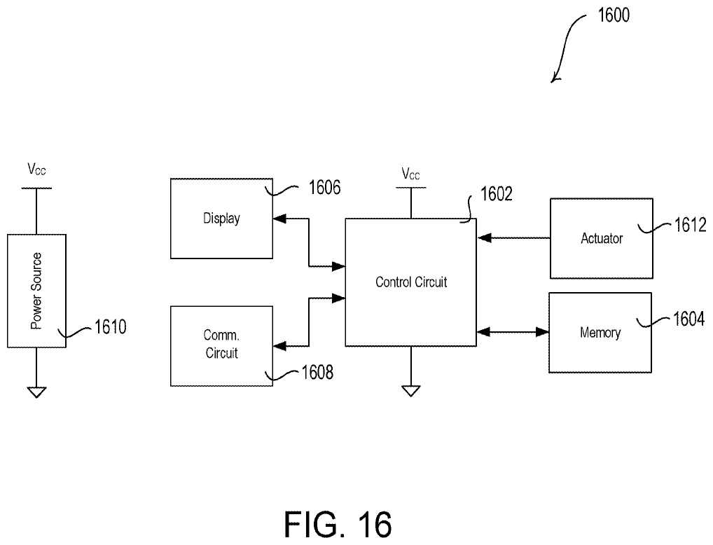

FIG. 16 is a block diagram illustrating an example network device 1600 as described herein. The network device 1600 a mobile user device. The network device 1600 may include a control circuit 1602 for controlling the functionality of the network device 1600. The control circuit 1602 may include one or more general purpose processors, special purpose processors, conventional processors, digital signal processors (DSPs), microprocessors, integrated circuits, a programmable logic device (PLD), application specific integrated circuits (ASICs), or the like. The control circuit 1602 may perform signal coding, data processing, power control, input/output processing, or any other functionality that enables the network device 1600 to perform as described herein. The control circuit 1602 may store information in and/or retrieve information from the memory 1604. The memory 1604 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory.

The network device 1600 may include a communications circuit 1608 for transmitting and/or receiving information. The communications circuit 1608 may perform wireless and/or wired communications. The communications circuit 1608 may include an RF transceiver or other circuit capable of performing wireless communications via an antenna. Communications circuit 1608 may be in communication with control circuit 1602 for transmitting and/or receiving information.

The network device 1600 (e.g., via the control circuit 1602) may communicate with a control-target device, e.g., a load control device 1400, as described herein. For example, the network device 1600 may communicate with a motor drive unit for a motorized window treatment to control a motorized window treatment (e.g., motorized window treatments 150, 150a, 150b) as described herein.

The control circuit 1602 may also be in communication with a display 1606 for providing information to a user. The processor 1602 and/or the display 1606 may generate GUIs for being displayed on the network device 1600. The display 1606 and the control circuit 1602 may be in two-way communication, as the display 1606 may include a touch screen capable of receiving information from a user and providing such information to the control circuit 1602. The network device 1600 may also include an actuator 1612 (e.g., one or more buttons) that may be actuated by a user to communicate user selections to the control circuit 1602.

For example, the network device 1600 may control a motorized window treatment (e.g., motorized window treatment 150) based the user actuating the actuator 1612 (e.g., one or more buttons) and perform manual controls.

Each of the circuits within the network device 1600 may be powered by a power source 1610. The power source 1610 may include an AC power supply or DC power supply, for example. The power source 1610 may generate a supply voltage VCC for powering the circuits within the network device 1600.

Although features and elements are described herein in particular combinations, each feature or element can be used alone or in any combination with the other features and elements. The methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), removable disks, and optical media such as CD-ROM disks, and digital versatile disks (DVDs).

What is claimed:

1. A motorized window treatment comprising:
a roller tube;
a covering material that is attached to the roller tube;
a motor drive unit configured to be located within the roller tube, the motor drive unit comprising a motor that is configured to rotate the roller tube to adjust the covering material between a raised position and a lowered position; and
a control unit mounted to or integrated into the roller tube, the control unit configured to communicate with the motor drive unit,
wherein the control unit is configured to adjust a visible light transmittance of the covering material by controlling one or more fabric characteristics of the covering material in response to a message received from the motor drive unit.

2. The motorized window treatment of claim 1, further comprising one or more wireless communication components configured to communicate wireless messages with an external control device.

3. The motorized window treatment of claim 2, wherein the motorized window treatment is configured to adjust the visible light transmittance of the covering material based on control instructions received from the external control device by the one or more wireless communication components.

4. The motorized window treatment of claim 1, wherein the control unit is configured to adjust the visible light transmittance of the covering material by changing a thickness of the covering material.

5. The motorized window treatment of claim 4, wherein the covering material comprises electrical wiring that is configured to conduct a current such that the temperature of the covering material can be increased and decreased.

6. The motorized window treatment of claim 4, wherein the covering material comprises a plurality of zones, and wherein the control unit is configured to adjust the visible light transmittance of each of the plurality of zones independently.

7. The motorized window treatment of claim 6, wherein the control unit is configured to control one or more upper zones of the plurality of zones to a first thickness and one or more lower zones of the plurality of zones to a second thickness.

8. The motorized window treatment of claim 4, wherein the control unit is configured to reduce the thickness of the covering material as the covering material is rolled onto the roller tube.

9. The motorized window treatment of claim 4, wherein the control unit is configured to increase the thickness of the covering material as the covering material is rolled off of the roller tube.

10. The motorized window treatment of claim 1, further comprising:
a plurality of light sources located in the covering material; and
wherein the control unit is configured to control one or more of an intensity or a color of the plurality of light sources.

11. The motorized window treatment of claim 10, wherein the motorized window treatment is configured to adjust one or more of the color or the pattern of the covering material.

12. The motorized window treatment of claim 10, wherein the plurality of light sources comprises fiber optics.

13. The motorized window treatment of claim 10, wherein the plurality of light sources comprises light-emitting diodes disposed on the covering material.

14. The motorized window treatment of claim 1, wherein the control unit comprises a covering material drive circuit and a control circuit in communication with the covering material drive circuit for controlling the visible light transmittance of the covering material.

15. The motorized window treatment of claim 14, wherein the control unit comprises a communication circuit configured to communicate messages with the motor drive unit, and wherein the control circuit is configured to receive a command for controlling the covering material in a message received via the communication circuit.

16. The motorized window treatment of claim 15, wherein the communication circuit is configured to communicate with the motor drive unit via a wireless communication channel.

17. The motorized window treatment of claim 14, wherein the covering material drive circuit is configured to conduct current through one or more zones of the covering material to adjust the visible light transmittance of the covering material.

18. The motorized window treatment of claim 14, wherein the control unit comprises an internal power supply configured to receive power from the motor drive unit and provide power to the covering material drive circuit and the control circuit.

19. The motorized window treatment of claim 1, wherein the motorized window treatment is configured to adjust a visible light transmittance of the covering material when the covering material is in a fixed position between the raised position and the lowered position.

20. The motorized window treatment of claim 1, wherein the roller tube comprises a first roller tube and the covering material comprises a first covering material, the motorized window treatment further comprising:
a second roller tube; and
a second covering material that is attached to the second roller tube, the second covering material comprising a blackout fabric having one or more light sources for illuminating the first covering material.

21. The motorized window treatment of claim 1, wherein the control unit is configured to adjust a color or pattern of the covering material.
